(19) United States
(12) Patent Application Publication
(10) Pub. No.: US 2003/0144467 A1
(43) Pub. Date: Jul. 31, 2003

(54) Matrix solid-phase organic synthesis

(76) Inventors: Morten Meldal, Copenhagen (DK); Leslie P. Miranda, New South Wales (AU)

Correspondence Address: BROWDY AND NEIMARK, P.L.L.C., 624 NINTH STREET, NW, SUITE 300, WASHINGTON, DC, 20001-5303, US

(21) Appl. No.: 10/270,245

(22) Filed: Oct. 15, 2002

Related U.S. Application Data
(60) Provisional application No. 60/330,459, filed on Oct. 22, 2001.

(30) Foreign Application Priority Data
Oct. 12, 2001 (DK) PA 2001 01512

(51) Int. Cl. C08G 65/34

(52) U.S. Cl. 528/425

(57) ABSTRACT

The present invention relates to a polymer matrix comprising a backbone of linked macromonomers, wherein said macromonomers are selected from the group consisting of triethylene glycols, tetraethylene glycols, and pentaethylene glycols, including any derivative and/or combination thereof. The polymer matrix of the present invention has a high-loading capacity while still being able to swell in small volumes of organic and aqueous solvents; it forms beads effectively so as to provide a resin of homogeneous size and shape; and it is more stable both chemically and physically than state of the art resins. One preferred type of SPOCC resin according to the present invention comprises short chained ethylene glycol macromonomers, including tetraethylene glycol (TEG₁₉₄), or derivatives thereof.

This application is a non-provisional of U.S. provisional application Serial No. 60/330,459 filed on Oct. 22, 2002, which is hereby incorporated by reference in its entirety.

All patent and non-patent references cited in the application, or in the present application, are also hereby incorporated by reference in their entirety.

### TECHNICAL FIELD OF THE INVENTION

The present invention is related to polymer resins having a high functional group density. The resins can be used for solid-phase organic synthesis as well as for a range of other purposes. One group of preferred resins comprises a backbone of homogeneous, oligoethylene glycol macromonomers, including tetraethylene glycol (TEG₁₉₄) (2,2′-(oxybis(ethyleneoxy))diethanol; CAS No: 112-60-7; EINECS No 203-989-9), linked by quaternary carbon junctions and terminated with a primary alcohol functionality.

### BACKGROUND OF THE INVENTION

The success of solid-phase chemistry is critically dependent upon the chemical composition and physical properties of the polymer matrix¹. Although the development of a universal support that possesses features ideally suited for all applications is unlikely, many polymers have proven effective for particular uses².

PS-DVB³ (polystyrene divinylbenzene) has been widely used for solid-phase peptide synthesis (SPPS), and has more recently demonstrated utility for the polymer-supported preparation of particular organic molecules⁴. When prepared properly⁵, PS-DVB supports display excellent properties for chemical synthesis such as high loading, reasonable swelling in organic solvents and physical stability. Drawbacks restricting the use of PS-DVB supports include poor compatiblity with aqueous solutions and polar solvents, and a polymer matrix that is reactive under electrophilic chemical conditions, as well as relatively poor properties for on-bead magic angle spinning (MAS) NMR analysis⁶.

The aromatic nature of PS-DVB particularly limits its employment in the modification of support-bound substrate under common solution-phase chemistry, such as the Friedel-Crafts acylation⁷ and related electrophilic reactions⁸. PEG-grafted resins, such as TentaGel S¹⁰, and PEG-cross-linked resins, such as PEGA¹¹ (polyethylene glycol-polyacrylamide copolymer); POEPOP¹² (polyoxyethylene-polyoxypropylene); POE-PS3¹³ (polyoxyethylene-polystyrene); SPOCC¹⁴ and HYDRA¹⁵ are aqueous compatible, and in general are more suitable for high-resolution MAS-NMR analysis⁶. PEGA supports have proven useful for enzymology studies, for example, the screening of peptide or peptide-based inhibitor libraries¹⁶.

Comparing a number of resins, the present inventors have previously found that Super Permeable Organic Combinatorial Chemistry (SPOCC)¹⁴ resins are among the most robust under various reaction conditions as they contain neither amide bonds nor polystyrene, both of which are prominent constituents in PEGA and TentaGel S, respectively.

Originally intended for use in both organic synthesis and solid-phase bioassaying, SPOCC polymers were initially designed to have a balance of physiochemical properties for both applications. Although SPOCC could be effectively used in peptide synthesis as well as for some organic chemistry, such as Wittig and Homer-Wadsworth-Emmons-type reactions¹⁴; prior to the on-bead assaying of resin-bound substrate, its high swelling capacity and moderate loading restricted the use of state of the art SPOCC in concentration sensitive chemistry.

GB 987 353 (Bayer A. G.) relates to a linear co-polymer, i.e. a polymer which is not cross-linked. The units of the linear co-polymer are linked by ester bonds. The present invention relates to a cross-linked polymer matrix.

Renil and Pillai (J. Appl. Pol. Sci. (1996), vol. 61, p. 1585-1594) describe a tetra-ethylene glycol diacrylate cross-linked polystyrene support for gel phase peptide synthesis.

Renil et al. (Tetrahedron (1994), vol. 50, no. 22, p. 6681-6688) describe gel phase peptide synthesis on a tetraethylene glycol diacrylate-cross-linked polystyrene support.

Renil and Pillai (Tetrahedron Lett. (1994), vol. 35, no. 22, p. 3809-3812) describe the synthesis of fully protected peptides on a tetraethylene glycol diacrylate-cross-linked polystyrene support.

WO 98/40425 relates to a swellable elastomer comprising both a hydrophobic part and a hydrophilic part forming a continuous matrix. The polymer matrix according to the present invention is hydrophilic in nature and does not contain a hydrophobic part in combination with a hydrophilic part.

WO 00/18823 relates to a macromonomer having from 6 to 300 ethylene glycol repeat units (see e.g. p. 3, top part), i.e. at least a hexaethylene glycol macromonomer. The present invention is directed to a cross-linked polymer matrix comprising macromonomers in the form of triethylene glycols, tetraethylene glycols and pentaethylene glycols.

WO 93/16118 and U.S. Pat No. 5,352,756 generally relate (see e g. FIG. 2) to macromonomers having a number of repeat units in excess of the repeat units forming macromonomers such as triethylene glycols, tetraethylene glycols and pentaethylene glycols.

A need exists for improved polymer resins for use in solid-phase chemistry; including solid-phase peptide synthesis (SPPS) as well as the preparation of particular organic molecules.

### SUMMARY OF THE INVENTION

The present invention provides a resin that alleviates the shortcomings of state of the art resins and makes it possible to tailor resins for solid-phase synthesis of low-molecular weight drug-like molecules and peptidomimetics.

The polymer resins according to the present invention have an improved mechanical stability and beads more readily than resins made from macromonomers having a longer chain length.

Yet another preferred feature of the resins according to the present invention is their ability to have a neutral boyency in water, i.e. they neither float nor sink, unlike some prior art resins.

One group of preferred resins according to the present invention comprises a back-bone of homogeneous, oligoethylene glycol macromonomers, including tetraethylene glycol (TEG₁₉₄; 2,2′-(oxybis(ethyleneoxy))diethanol; GAS No, 112-60-7; EINECS No: 203-989-9), or a derivative thereof, which macromonomers are preferably linked by quaternary carbon junctions and terminated with a primary alcohol functionality, such as an —OH group.

Further aspects of the present invention relates to a beaded, cross-linked polymer comprising resins according to the present invention comprising a backbone of homogeneous, oligoethylene glycol macromonomers, as well as various uses of such resins or beaded polymers.

The invention also relates to compositions comprising a beaded, cross-linked polymer of predetermined dimensions, wherein said polymer comprises a resin according to the present Invention comprising a backbone of homogeneous, oligoethylene glycol macromonomers.

In further aspects there are provided a functional surface comprising a polymer matrix according to the present invention, as well as a method for preparing such a functional surface.

In still further aspects there are provided a method for targeting a functional moiety attached to a functional surface; a method for identifying and/or purifying a targeting species having an affinity for a functional moiety; targeting species identified by such a method, and a method for therapy comprising the step of administering to an animal body an identified targeting species.

### FIGURE LEGENDS

FIG. 1. Synthesis of SPOCC₁₉₄ resin.

FIG. 2. Microscope image of beads of SPOCC₁₉₄ obtained by suspension polymerization in silicon oil at room temperature.

FIG. 3. Comparison of AMPS, SPOCC₁₉₄, SPOCC₁₅₀₀, PEGA₁₉₀₀ and TentaGel S resins. (A) Swelling estimates in DCM, unless otherwise indicated; (B) Expression of functional group density in mmol/mL DCM.

FIG. 4. Comparison of reaction rates on AMPS (triangles), SPOCC₁₉₄ (squares), SPOCC₁₅₀₀ (diamonds), and TentaGel S (circles). 1.5 equivalents of Boc-Val-OSu was dissolved in a minimal amount of DMF to permit coverage of the beads. A time course of the reactions at 1, 5, 10, 30, 180 and 1080 min intervals and the incorporation of valine determined by amino acid analysis (AA).

FIG. 5. (A) Solid-phase glycosylation of a SPOCC₁₉₄ bound peptide, PLL indicates photolabile linker; (B) Reversed-phase HPLC analysis of the crude product; (C) Electrospray mass spectrum of the crude product.

FIG. 6. β-Eliminating sulfone safety-catch linker system on SPOCC₁₉₄.

FIG. 7. Friedel-Crafts acylation chemistry SPOCC,₁₉₄ using a sulfone-based safety-catch linker strategy for the release of tertiary amines. Conditions. (i) 20 equiv mesyl chloride, Py/DCM; (ii) Boc-piperazine, 10% TEA/DMF, 45° C., overnight (iii) 30% H₂O₂ and 5% acetic acid, (iv) TFA; (v) BzIBr, DBU, 45° C., overnight; (vi) mCPBA/DCM (15 mg/mL), rt, 2h; (vii) CH₃l, DMA, 3 d; (viii) 5 equiv p—NO₂—C₆H₄—COCl, 25 equiv AlCl₃, anhydrous nitrobenzene, 8 h. (ix) 5 equiv DBU/DMF, rt, overnight.

### DETAILED DESCRIPTION OF THE INVENTION

Although previously working on the exploitation of resins comprising long chain polyethylene glycols (PEGs) for for solid-phase synthesis of low-molecular weight drug-like molecules and peptidomimetics⁹, resins comprising a backbone of homogeneous, short chained ethylene glycol macromonomers, including tetraethylene glycol (TEG₁₉₄; 2,2′-(oxybis(ethyleneoxy))diethanol), and/or derivatives thereof, have previously not been disclosed. The PEG-cross-linked SPOCC₁₉₄ resins according to the present invention are more stable both chemically and physically than are state of the art SPOCC resins.

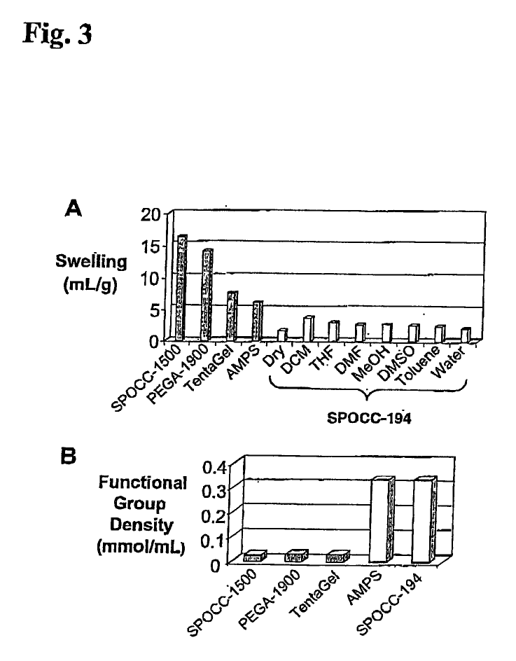

A comparison of resin loading and swelling in DCM (dichlormethane) for selected resins as reported herein below (FIG. 3) illustrates the low concentration of active sites available when state of the art PEG-based resins are used in their ideal swelling volumes: TentaGel S (0.03 mmol/mL), PEGA₁₉₀₀ (0.015 mmol/mL), and SPOCC₁₅₀₀ (0.025 mmol/mL).

Considerable reactant dilution is therefore necessary to enable resin solvation with these PEG-based resins. This poses a limitation when expensive reagents and valuable intermediates must be employed in high excess as solution-phase reactants. Because high reactant concentrations are desirable for driving solid-phase reactions to completion, high-loading/low-swelling resins like PS-DVB are still generally preferred in the art for solid-phase organic synthesis.

Ideally, a PEG-based polymer for organic synthesis would possess a high-loading capacity while still being able to swell in small volumes of organic and aqueous solvents.

PEG-based polymer for organic synthesis should also preferably bead effectively in order to provide a resin of homogeneous size and shape so that chemistry can be performed uniformly and in a homogeneous environment on the support-bound substrate.

Additionally, at the molecular level, the resin should preferably be chemically pure and ideally homogeneous in terms of macromonomer chain-length and polymer branching points in order to avoid multiple micro-environments which may compromise reactivity as well as complicate an on-bead analysis.

The present invention relates to a resins, i) having a high-loading capacity while still being able to swell in small volumes of organic and aqueous solvents, ii) forming beads effectively so as to provide a resin of homogeneous size and shape; and iii) being more stable both chemically and physically than state of the art resins.

One preferred type of SPOCC resin according to the present invention comprises, essentially consists of, or consists of, short chained ethylene glycol macromonomers, including tetraethylene glycol (TEG₁₉₄), or derivatives thereof. Resins comprising, essentially consisting of, or consisting of tetraethylene glycol (TEG₁₉₄) are referred to as SPOCC₁₉₄ herein below. It is understood that the invention also relates to resins comprising derivatives of TEG₁₉₄ as defined herein below.

Preferred resins according to the present invention further comprises—in addition to TEG ₁₉₄, or a derivative thereof—primary or secondary ether bonds, more preferably primary ether bonds, quaternary carbon junction points, and primary and/or secondary alcohol functionalities, more preferably primary alcohol functionalities.

The term short chained ethylene glycol macromonomer as used herein refers to triethylene glycols, tetraethylene glycols, and pentaethylene glycols, as well as any derivative thereof. The term short chained ethylene glycol macromonomer is used interchangably with oligoethylene glycol macromomer.

Derivatives of a short chained ethylene glycol macromonomer refers to any short chained ethylene glycol, wherein one or both of the primary alcohol functionalities have been reacted, together or independently of one another, with a chemical group selected from an aliphatic group, a cyclic group, or a combination of a aliphatic and cyclic groups (e,g. aralkyl groups). The aliphatic and/or cyclic group will be understood to comprise a functionality which allows the reaction with the primary alcohol functionalities of the polyethylene glycol to occur. The skilled person will know how to select functionalities capable of reacting with a primary alcohol functionality, and he will know how to carry out such reactions.

In the context of the present invention, the term “aliphatic group” means a saturated or unsaturated linear or branched hydrocarbon group. This term is used to encompass alkyl, alkenyl, and alkynyl groups, for example.

The term “alkyl group” means a saturated linear or branched hydrocarbon group Including, for example, methyl, ethyl, isopropyl, t-butyl, heptyl, dodecyl, octadecyl, amyl, 2-ethylhexyl, and the like.

The term “alkenyl group” means an unsaturated, linear or branched hydrocarbon group with one or more carbon-carbon double bonds, such as a vinyl group.

The term “alkynyl group” means an unsaturated, linear or branched hydrocarbon group with one or more carbon-carbon triple bonds.

The term “cyclic group” means a closed ring hydrocarbon group that is classified as an alicyclic group, aromatic group, or heterocyclic group.

The term “alicyclic group” means a cyclic hydrocarbon group having properties resembling those of aliphatic groups.

The term “aromatic group” or “aryl group” means a mono or polycyclic aromatic hydrocarbon group.

The term “heterocyclic group” means a closed ring hydrocarbon in which one or more of the atoms in the ring is an element other than carbon (e.g., nitrogen, oxygen, sulfur, etc).

As is well understood in this technical area, a large degree of substitution is not only tolerated, but is often advisable. Substitution is anticipated on the materials of the present invention. As a means of simplifying the discussion and recitation of certain terminology used throughout this application, the terms “group” and “moiety” are used to differentiate between chemical species that allow for substitution or that may be substituted and those that do not allow or may not be so substituted.

Thus, when the term “group” is used to describe a chemical substituent, the described chemical material includes the unsubstituted group and that group with O, N, or S atoms, for example, in the chain as well as carbonyl groups or other conventional substitution. Where the term “moiety” is used to describe a chemical compound or substituent, only an unsubstituted chemical material is intended to be included.

For example, the phrase “alkyl group” is intended to include not only pure open chain saturated hydrocarbon alkyl substituents, such as methyl, ethyl, propyl, t-butyl, and the like, but also alkyl substituents bearing further substituents known in the art, such as hydroxy, alkoxy, alkylsulfonyl, halogen atoms, cyano, nitro, amino, carboxyl, etc, Thus, “alkyl group” includes ether groups, haloalkyls, nitroalkyls, carboxyalkyls, hydroxyalkyls, sulfoalkyls, etc, On the other hand, the phrase “alkyl moiety” is limited to the inclusion of only pure open chain saturated hydrocarbon alkyl substituents, such as methyl, ethyl, propyl, t-butyl, and the like. The same definitions apply to “alkenyl group” and “alkenyl moiety”; to “alkynyl group” and “alkynyl moiety”; to “cyclic group” and “cyclic moiety; to “alicyclic group” and “alicyclic moiety”; to “aromatic group” or “aryl group” and to “aromatic moiety” or “aryl moiety”; as well as to to “heterocyclic group” and “heterocyclic moiety”.

SPOCC₁₉₄ resins are capable of being used for a range of solid-phase organic chemistry applications. The resins maintain their chemical inertness and physical stability of SPOCC resins prepared with longer chain macromonomers. However, SPOCC₁₉₄ resins possess at least an order-of-magnitude higher loading capacity to swelling volume ration (such as e.g. at least 0.3 mmol/mL in DCM).

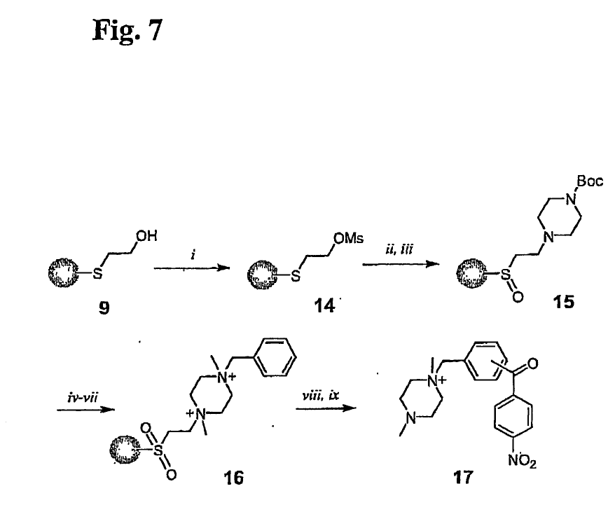

Furthermore, SPOCC₁₉₄ resin can be effectively prepared in a unified beaded form by controlled suspension polymerization in silicon oil. By employing homogeneous tetraethylene glycol (TEG₁₉₄) as macromonomer, it is possible to minimize variations in the micro-environments within the resin and to facilitate or improve on-bead monitoring. The merits of SPOCC₁₉₄ have been validated by performing peptide and selective electrophilic chemistry; such as glycosylations and Friedel-Crafts acylations, on support-bound substrate (FIG. 7).

The examples reported herein below demonstrate the utility of SPOCC₁₉₄ resins comprising a backbone of preferably homogeneous tetraethylene glycol (TEG₁₉₄) macromonomers linked by quaternary carbon junctions and terminated with primary alcohol functionality.

Uniform beaded SPOCC₁₉₄ resin was effectively synthesized by suspension polymerization of oxetanylated TEG-macromonomer 5 in silicon oil. Mechanically stable and inert to a diverse range of reaction conditions, SPOCC₁₉₄ possessed a high hydroxyl group loading (0.9-1.2 mmol/g) for substrate attachment and swelled effectively (-2-4 mL/g) in a variety of organic and aqueous solvents.

Designed for solid-phase synthesis at high reactant concentrations for driving organic and aqueous reactions to completion, SPOCC194 exhibited a high loading/swelling ratio similar to that of polystyrene-divinylbenzene copolymers (PS-DVB) yet significantly higher than PEGA₁₉₀₀, SPOCC₁₅₀₀, and TentaGel S resins.

Because functional group pseudo-dilution was minimized, superior reaction kinetics were observed when employing a limited amount of reagent, and SPOCC₁₉₄ resin (1) relative to those observed with PEG-based resins that exhibited low loading/swelling ratios such as SPOCC₁₅₀₀ and TentaGel S.

The MAS-NMR spectral quality of SPOCC₁₉₄ indicates that in most cases it should be possible to monitor functional group transformations directly on-bead. By employing a non-aromatic β-elimination safety-catch linker, AlCl₃-catalyzed Friedel-Crafts acylation was selectively performed on substrate attached to SPOCC₁₉₄ resin.

Relative to contemporary resins, SPOCC₁₉₄ resin exhibits multiple advantages for solid-phase synthesis including uniform beading, a high functional group density (mmol/mL), compatibility in organic and aqueous solvents as well as inertness under electrophilic reation conditions. Such properties make SPOCC₁₉₄ resin a promising new polymer matrix for the support-bound construction of small organic molecules by parallel and combinatorial synthesis, and the scavenging of solution-phase reactants or by-products,

In summary, the present invention has provided a well-defined, high quality SPOCC₁₉₄ resin (1) that is well suited to the requirements of organic synthesis. SPOCC₁₉₄ is the most stable ethylene glycol cross-linked resin reported to date. It is able to withstand conditions that are not compatible or suitable with PS-DVB or Tentagel supports.

In one preferred embodiment, the present invention provides a polymer matrix comprising, essentially consisting of, or consisting of, a backbone of cross-linked macromonomers, wherein said macromonomers are selected from the group consisting of triethylene glycols, tetraethylene glycols, and pentaethylene glycols, including any derivative and/or combination thereof.

In another preferred embodiment, there is provided a polymer matrix comprising, essentially consisting of, or consisting of, a backbone of cross-linked macromonomers, wherein said macromonomers are selected from the group consisting of triethylene glycols, tetraethylene glycols, and pentaethylene glycols, including any derivative thereof.

In a preferred embodiment there is provided a matrix wherein at least two neighbouring macromonomers comprising an oligoethylene glycol, such as a triethylene glycol, for example a tetraethylene glycol, such as a pentaethylene glycol, are linked to each other by means of a covalent bond such as e.g. a quaternary carbon bond; a quaternary carbon bond in combination with a primary ether bond; or a secondary ether bond.

The polymer matrix preferably does not comprise styrene when the tetraethylene glycol derivative is tetraethylene glycol diacrylate and/or tetraethylene glycol dimethacrylate.

In yet another preferred embodiment, there is provided a polymer matrix comprising, essentially consisting of, or consisting of a backbone of cross-linked macromonomers, wherein said macromonomers are selected from the group consisting of triethylene glycol, tetraethylene glycol, and pentaethylene glycol, including any combination thereof.

The term “glycols” refers to both the individual compound in question (e.g. tetraethylene glycol) as well as derivatives thereof, as defined herein. The term “glycol” refers to the individual compound itself (e.g. tetraethylene glycol), excluding derivatives thereof.

The term “cross-linked” refer to a branched matrix or resin obtained by joining adjacently located macromonomers via covalent bonds. Preferred covalent bonds are listed herein below and includes, but is not limited to quaternary carbon bonds, optionally in combination with primary ether bonds, and secondary ether bonds.

A polymer matrix essentially consisting of a backbone of cross-linked oligoethylene glycol macromonomers generally has a content of from about 50% to about 70% (w/w) of the oligoethylene glycol(s) in question incorporated into the backbone. A polymer matrix consisting of a backbone of cross-linked oligoethylene glycol macromonomers generally has a content of from about 70% to about 95% (w/w) of the oligoethylene glycol(s) in question incorporated into the backbone.

The oligoethylene glycols of the present invention confer a hydrophilic nature on the polymer matrix. The SPOCC₁₉₄ resin is one example of a hydrophilic resin according to the present invention.

The macromonomers according to the invention are preferably linked by quaternary carbon junctions, by primary ether bonds, or by quaternary carbon junctions and primary ether bonds. However, the macromonomers can also be linked by e.g. secondary ether bonds as well as any other form of chemical bond including, but not limited to the examples of chemical bonds listed herein below.

It is preferred in one embodiment that at least one end of the matrix terminates in a primary alcohol functionality. In other embodiments at least one end of the matrix terminates in a secondary alcohol functionality, and in still further embodiments, at least one first end of the matrix terminates in a primary alcohol functionality and at least one second end of the matrix terminates in a secondary alcohol functionality. “Alcohol functionality” refers to a reactive alcohol group capable of forming—upon reaction—a chemical bond.

When the macromonomers are linked by e g. secondary ether bonds, the matrix preferably comprises at least one first end terminating in a secondary alcohol functionality, and preferably also a second end terminating in a primary alcohol functionality. Such matrixes can be characterised by a ratio R=a/b of essentially 1 (one), wherein a is the number of primary alcohol functionalities and b is the number of secondary alcohol functionalities. Essentially 1 shall comprise a value of from 0.7 to 1.3, such as a value of from 0.8 to 1.2, for example a value of from 0.9 to 1.1.

In one embodiment the matrix is selected from the group consisting of polyoxetane-triethyleneglycol, polyoxetane-tetraethyleneglycol, and polyoxetane-pentaethyleneglycol, including any combination and/or derivative thereof. The matrix preferably comprises the structure

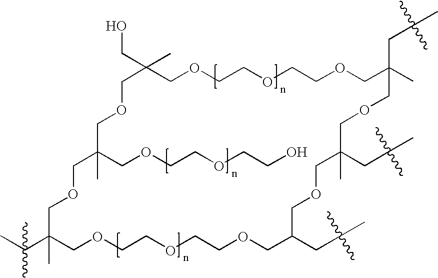

wherein n is 2, 3 and/or 4. In one preferred embodiment, n is 2 and/or 3

Another preferred matrix is selected from the group consisting of polyglycerol-triethyleneglycol, polyglycerol-tetraethyleneglycol, and polyglycerol-pentaethylene-glycol, including any combination and/or derivative thereof. The matrix preferably comprises the structure

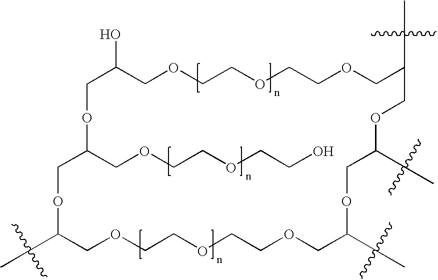

wherein n is 2, 3 and/or 4. In one preferred embodiment, n is 2 and/or 3.

Yet another preferred matrix is selected from the group consisting of poly(acryl)amide-triethyleneglycol, poly(acryl)amide-tetraethyleneglycol, and poly(acryl)amide-pentaethyleneglycol, including any combination and/or derivative thereof. The matrix preferably comprises the structure

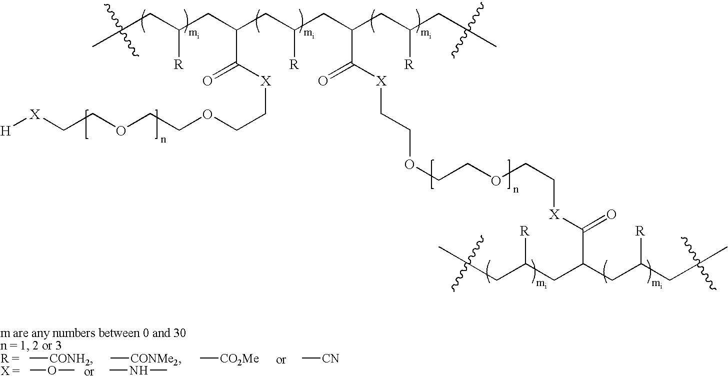

In one preferred embodiment, there is provided a matrix wherein n is 1, wherein n is 2, and, wherein n is 3, respectively. In another preferred embodiment, n is 2 and/or 3. Irrespective of whether n is 1, 2, or 3, it is preferred in one embodiment that R is —CONH₂. In another embodiment, R is —CONMe₂. In a further embodiment, R is —CO₂Me, and in a still further embodiment, R is —CN.

Irrespective of whether n is 1, 2, or 3, and irrespective of whether R is —CONH₂, —CONMe₂; —CO₂Me, or —CN, X can be —O—or —NH—. A more preferred matrix is one wherein n is 2, wherein R is —CONH₂, and wherein X is —O—.

In one embodiment, the polymer matrix according to the invention has a matrix loading capacity, including a hydroxyl group loading capacity, in the range of from 0.2 mmol/gram to preferably less than 2.0 mmol/gram, such as in the range of from 0.4 mmol/gram to preferably less than 1.8 mmol/gram, for example in the range of from 0.6 mmol/gram to preferably less than 1.6 mmol/gram, such as in the range of from 0.8 mmol/gram to preferably less than 1.4 mmol/gram, for example in the range of from 0.9 mmol/gram to preferably less than 1.2 mmol/gram.

In one embodiment, the polymer matrix according to the invention has a swelling volume in an aqueous liquid, including water, of from 1 ml/gram to preferably less than 5 ml/gram.

It is preferred that the ratio between i) matrix loading capacity, including hydroxyl group loading capacity, and ii) matrix swelling volume in an aqueous liquid, including water, is in the range of from 0.1 mmol/ml to preferably less than 1.8 mmol/ml, such as in the range of from 0.1 mmol/ml to preferably less than 1.5 mmol/ml, for example in the range of from 0.1 mmol/ml to preferably less than 1.2 mmol/ml, such as in the range of from 0.1 mmol/ml to preferably less than 1.0 mmol/ml, for example in the range of from 0.1 mmol/ml to preferably less than 0.75 mmol/ml, such as in the range of from 0.1 mmol/ml to preferably less than 0.5 mmol/ml, for example in the range of from 0.1 mmol/ml to preferably less than 0.3 mmol/ml, such as in the range of from 0.3 mmol/ml to preferably less than ..5 mmol/ml, for example in the range of from 0.5 mmol/ml to preferably less than 1.5 mmol/ml, such as in the range of from 0.75 mmol/ml to preferably less than 1.5 mmol/ml, for example in the range of from 1.0 mmol/ml to preferably less than 1.5 mmol/ml.

Matrix loading capacity, such as, but not limited to hydroxyl group loading capacity and amine group loading capacity, is determined by state of the art methods known to the skilled person. For example, resins with hydroxyl functionalities (—OH groups) were reacted with Fmoc-Gly-OH (4 eqv.), 1-mesitylenesulfonyl-3-nitro-1,2,4-triazole (3.9 eqv) and N-methylimidazol (4 eqv.) in dichloromethane for 1 hour and the reagents were filtered off. The reaction was repeated and the resin was washed with dichloromethane, DMF, dichloromethane and dried. A sample of the dry resin was weighed out and the Fmoc group was cleaved with 20% piperidine in DMF. The reactants and the washings were collected and diluted to 25 ml. The UV-absorbance of the solution at 305 nm was recorded and compared with a standard curve to give the hydroxyl loading capacity.

For swelling measurements, dry resin beads (1 gram of e.g. SPOCC₁₉₄, AMPS, PEGA₁₉₀₀ and SPOCC₁₅₀₀) were placed in a graduated flat-bottom luer syringe fitted with a sintered Teflon filter (50 μm pore size) and swollen in the appropriate solvent for 30 min. The solvated resin bed was then squeezed with a flat plunger with an approximately 50 psi downforce to exclude excess solvent volume. The force was released and the swollen volume was measured. This procedure and measurement was performed in triplicate for each resin sample (typically with ±0.1-0.2 mL reproducibility) and the values were averaged¹⁹.

Although the polymer matrix can contain different macromonomers, it is preferred in one embodiment that all of said macromonomers are identical. The identical macromomers are preferably triethylene glycol, tetraethylene glycol, or pentaethylene glycol, including any derivative thereof.

When containing different macromonomers, the polymer matrix preferably comprises a mixture of triethylene glycol and tetraethylene glycol, or a mixture of triethylene glycol and pentaethylene glycol, or a mixture of tetraethyleneglycol and pentaethylene glycol, or a mixture of triethylene glycol, tetraethylene glycol and pentaethylene glycol.

In any one of such mixtures, it is preferred that at least 50% (w/w) ) of said macromonomers are tetraethylene glycol, such as at least 60% (w/w) ) of said macromonomers are tetraethylene glycol, for example at least 70% (w/w) ) of said macromonomers are tetraethylene glycol, such as at least 80% (w/w) of said macromonomers are tetraethylene glycol, such as at least 85% (w/w) of said macromonomers are tetraethylene glycol, for example at least 90% (w/w) of said macromonomers are tetraethylene glycol, such as at least 95% (w/w) of said macromonomers are tetraethylene glycol, for example at least 99% (w/w) of said macromonomers are tetraethylene glycol, such as essentially all of said macromonomers are tetraethylene glycol

In another preferred embodiment of the invention there is provided a polymer matrix wherein macromonomers selected from the group consisting of triethylene glycol, tetraethylene glycol and pentaethylene glycol constitutes at least 60% (w/w) of the weight of the polymer matrix, such as at least 65% (w/w), for example at least 70%(w/w), such as at least 75% (w/w), for example at least 80% (w/w) such as at least 85% (w/w), for example at least 90% (w/w), such as at least 95% (w/w) of the weight of the polymer matrix.

The above mentioned group of macromonomers according to the invention can e.g. be selected from triethylene glycol and tetraethylene glycol, from triethylene glycol and pentaethylene glycol, from tetraethylene glycol and pentaethylene glycol, and from triethylene glycol and tetraethylene glycol and pentaethylene glycol.

It Is preferred in some embodiments that the macromonomers are not linked by amide bonds and/or that the polymer matrix does not comprise a polystyrene comprising portion.

The polymer matrix in one embodiment preferably has a spherical form, such as the form of a beaded, cross-linked polymer comprising a matrix according to the invention having a diameter in the range of from about 0.1 μm to preferably less than about 5 mm, such as a range of from 0.1 μm to 0.2 μm, for example a range of from 0.2 μm to 0,4 μm, such as a range of from 0.3 μm to 0.6 μm, for example a range of from 0.4 μm to 0.8 μm, such as a range of from 0.5 μm to 1.0 μm, for example a range of from 1.0 μm to 2.0 μm, such as a range of from 1.5 μm to 3.0 μm, for example a range of from 2.0 μm to 4.0 μm, such as a range of from 4.0 μm to 8.0 μm, for example a range of from 6.0 μm to 12 μm, such as a range of from 8.0 μm to 16 μm, for example a range of from 10 μm to 20 μm, such as a range of from 15 μm to 30 μm, for example a range of from 20 μm to 40 μm, such as a range of from 30 μm to 60 μm, for example a range of from 40 μm to 80 μm, such as a range of from 50 μm to 100 μm, for example a range of from 60 μm to 120 μm, such as a range of from 70 μm to 140 μm, for example a range of from 80 μm to 160 μm, such as a range of from 90 μm to 180 μm, for example a range of from 100 μm to 200 μm, such as a range of from 200 μm to 400 μm, for example a range of from 400 μm to 800 μm, such as a range of from 800 μm to 1200 μm, for example a range of from 1200 μm to 1600 μm, such as a range of from 1600 μm to 2000 μm, for example a range of from 2000 μm to 2400 μm, such as a range of from 2400 μm to 2800 μm, for example a range of from 2800 μm to 3200 μm, such as a range of from 3200 μm to 3600 μm, for example a range of from 3600 μm to 4000 μm, such as a range of from 4000 μm to 4400 μm, for example a range of from 4400 μm to 4800 μm, such as a range of from 4800 μm to 5200 μm.

In another embodiment, the average diameter of the beaded, cross-linked polymers comprising a matrix according to the invention is about 0.1 μm; for example about 0.2 μm, such as about 0.3 μm, for example about 0.4 μm, such as about 0.5 μm, for example about 1.0 μm, such as about 1.5 μm, for example about 2.0 μm, such as about 4.0 μm, for example about 6.0 μm, such as about 8.0 μm, for example about 10 μm, such as about 15 μm, for example about 20 μm, such as about 30 μm, for example about 40 μm, such as about 50 μm, for example about 60 μm, such as about 70 μm, for example about 80 μm, such as about 90 μm, for example about 100 μm, such as about 200 μm, for example about 400 μm, such as about 800 μm, for example about 1200 μm, such as about 1600 μm, for example about 2000 μm, such as about 2400 μm, for example about 2800 μm, such as about 3200 μm, for example about 3600 μm, such as about 4000 μm, for example about 4400 μm, such as about 4800 μm.

The beaded, cross-linked polymer matrix is preferably formed by polymerisation of droplets in silicon oil, by bulk polymerisation, by reverse suspension polymerisation, by spray polymerisation, or by any other conventionel method for preparing a cross-linked polymer matrix.

In other preferred embodiments there are provided the use of the polymer matrix or the beaded, cross-linked polymer according to the invention for a support for the synthesis of an organic molecule; the use of the polymer matrix or the beaded, cross-linked polymer according to the invention for solid phase enzyme reactions; the use of the polymer matrix or the beaded, cross-linked polymer according to the invention for a support for the synthesis of a peptide, a protein, a DNA, and a RNA; the use of the polymer matrix or the beaded, cross-linked polymer according to, the invention for protein immobilisation or affinity purification; as well as the use of the polymer matrix or the beaded, cross-linked polymer according to the invention for a support for combinatorial chemistry.

There is also provided the use of a macromonomer selected from the group consisting of triethylene glycol, tetraethylene glycol, and pentaethylene glycol, including any derivative and/or combination thereof, in the preparation of a beaded, cross-linked polymer matrix.

In one embodiment, there is provided a composition comprising a plurality of beaded, cross linked polymers comprising a polymer matrix according to the invention.

The beaded, cross-linked polymers preferably has a diameter in the range of from about 0.1 μm to preferably less tan about 5 mm, such as a range of from 0.1 μm to 0.2 μm, for example a range of from 0.2 μm to 0.4 μm, such as a range of from 0.3 μm to 0.6 μm, for example a range of from 0.4 μm to 0.8 μm, such as a range of from 0.5 μm to 1.0 μm, for example a range of from 1.0 μm to 2.0 μm, such as a range of from 1.5 μm to 3.0 μm, for example a range of from 2.0 μm to 4.0 μm, such as a range of from 4.0 μm to 8.0 μm, for example a range of from 6.0 μm to 12 μm, such as a range of from 8.0 μm to 16 μm, for example a range of from 10 μm to 20 μm, such as a range of from 15 μm to 30 μm, for example a range of from 20 μm to 40 μm, such as a range of from 30 μm to 60 μm, for example a range of from 40 μm to 80 μm, such as a range of from 50 μm to 100 μm, for example a range of from 60 μm to 120 μm, such as a range of from 70 μm to 140 μm, for example a range of from 80 μm to 160 μm, such as a range of from 90 μm to 180 μm, for example a range of from 100 μm to 200 μm, such as a range of from 200 μm to 400 μm, for example a range of from 400 μm to 800 μm, such as a range of from 800 μm to 1200 μm, for example a range of from 1200 μm to 1600 μm, such as a range of from 1600 μm to 2000 μm, for example a range of from 2000 μm to 2400 μm, such as a range of from 2400 μm to 2800 μm, for example a range of from 2800 μm to 3200 μm, such as a range of from 3200 μm to 3600 μm, for example a range of from 3600 μm to 4000 μm, such as a range of from 4000 μm to 4400 μm, for example a range of from 4400 μm to 4800 μm, such as a range of from 4800 μm to 5200 μm. The above compositions can be achieved by e.g. passing a prepared polymer matrix through a sieve.

In another embodiment, the particle size (average diameter) in the composition of beaded, cross-linked polymers comprising a matrix according to the invention is about 0.1 μm; for example about 0.2 μm, such as about 0.3 μm, for example about 0.4 μm, such as about 0.5 μm, for example about 1.0 μm, such as about 1.5 μm, for example about 2.0 μm, such as about 4.0 μm, for example about 6.0 μm, such as about 8.0 μm, for example about 10 μm, such as about 15 μm, for example about 20 μm, such as about 30 μm, for example about 40 μm, such as about 50 μm, for example about 60 μm, such as about 70 μm, for example about 80 μm, such as about 90 μm, for example about 100 μm, such as about 200 μm, for example about 400 μm, such as about 800 μm, for example about 1200 μm, such as about 1600 μm, for example about 2000 μm, such as about 2400 μm, for example about 2800 μm, such as about 3200 μm, for example about 3600 μm, such as about 4000 μm, for example about 4400 μm, such as about 4800 μm.

In yet another embodiment of the present invention there is provided a functional surface comprising a polymer matrix according to invention and attached thereto at least one functional moiety or “building block” . The surface is preferably solid and can further comprise a linker residue.

A functional moiety, including a functional group, can be any chemical which can undergo a chemical reaction to form a new bond. Because the functional moieties/“building blocks” and the reaction conditions are not limited, a broad spectrum of chemical reactions can be carried out. The bond formed by a chemical reaction involving a functional moiety/“building block” can be any desired type of covalent or organometallic bond. Examples of such bonds including the following: carbon-carbon single bond, carbon-carbon double bond, organometallic, heterocyclic (where the heterocyclic product may be aromatic or saturated), peptide (R¹ CONHR²), ester (R¹C(O)OR²), sulfonamide (R¹SO²NR²), thioester (R¹C(O)SR²), phosphodiester (R¹OP(O)R²), ether (R¹COCR²), thioether (R¹CSCR²), amide (R¹C(O)N(R²)R³), phosphamide (R¹P(O)NH—), amine (R¹N(R²)R³) and azo (—CNNC); where each R¹, R², and R³ may be the same or different, cyclic or acyclic; may be, for example, hydrogen, alkyl, alkenyl, alkynyl, heterocyclic, or aryl; and may contain one or more functional groups. The definition of the above-listed classes of compounds is provided herein elsewhere and apply to “derivatives of macromonomers ” as well as to “functional moieties” as exemplified herein above. Also, the above-listed chemical bonds are non-limiting examples of bonds capable of linking neighbouring macromomers (as defined herein elsewhere) in a polymer matrix according to the present invention.

A “chemical reaction” as used herein above preferably does not include the formation of hydrogen bonds such as the hybridization of double-stranded DNA or the solubilization of a salt or compound in a liquid phase.

The functional moiety/“building block” can be an organic chemical preferably selected from natural or unnatural moieties including alkanes, alkenes, dienes, dienophiles, alkynes, aromatic compounds, heterocyclic compounds, ethers, amines, amides, esters, thioesters, compounds containing a carbon-hetero multiple bond, L-amino acids, D-amino acids, synthetic amino acids, nucleotides, sugars, lipids and carbohydrates.

There is also provided a method for preparing a functional surface according to the invention, said method comprising the steps of

i) cross-linking a plurality of macromonomers selected from the group consisting of triethylene glycol, tetraethylene glycol, and pentaethylene glycol, including any combination thereof, and

ii) contacting said functional surface comprising said cross-linked polymer with at least one functional moiety.

Also provided is a method for targeting a functional moiety attached to a functional surface, said method comprising the steps of

i) providing a functional surface according to the invention, and

ii) targeting said functional moiety with at least one targeting species having an affinity for said functional moiety.

In a further embodiment there is provided a method for identifying and/or purifying a targeting species having an affinity for a functional moiety, said method comprising the steps of

i) providing a functional surface according to the invention, and

ii) targeting said functional moiety with at least one targeting species having an affinity for said functional moiety, and

iii) identifying and/or purifying the at least one targeting species having an affinity for said functional moiety.

Targeting species identified by the above method are also provided by the present invention, as is a method for therapy of a human or animal body, said method comprising the step of administering to said human or animal body an identified targeting species in a pharmaceutical effective amount.

In yet another embodiment there is provided an assay kit for the identification of e.g. pharmaceutical lead compounds. The assay kit preferably comprises a well plate apparatus containing an array of discrete functional moieties, or mixtures thereof, and biological assay materials. The biological assay materials employed will be those predictive of success for an associated disease state. Illustrative biological materials useful in the kit of the present invention are those required to perform e.g. the following assays: enzymatic inhibition, receptor-ligand binding, protein-protein interaction, protein-DNA interaction, cell-based functional assays, transcriptional regulation, signal transduction/second messenger, viral infectivity, incubate and read assays, scintillation proximity assays, angiotensin II IPA receptor bidning assay, endothelia convertin enzym ¹²⁵I SPA assay, HIV proteinase ¹²⁵I SPA enzyme assay, cholesteryl ester transfer (CETP) ³H SPA assay, fluorescence correlation spectros-copy, colorimneric biosensors, Ca²⁺ EGTA for cell-based assays, receptor gene constructs for cell-based assays, lucerferase, green fluorescent protein, beta-lactamase, and electrical cell impedance sensor assays.

The present invention is exemplified further below. The examples are illustrative only and the invention should not be limited to what is merely exemplified herein.

### EXAMPLE 1

### Materials and Methods

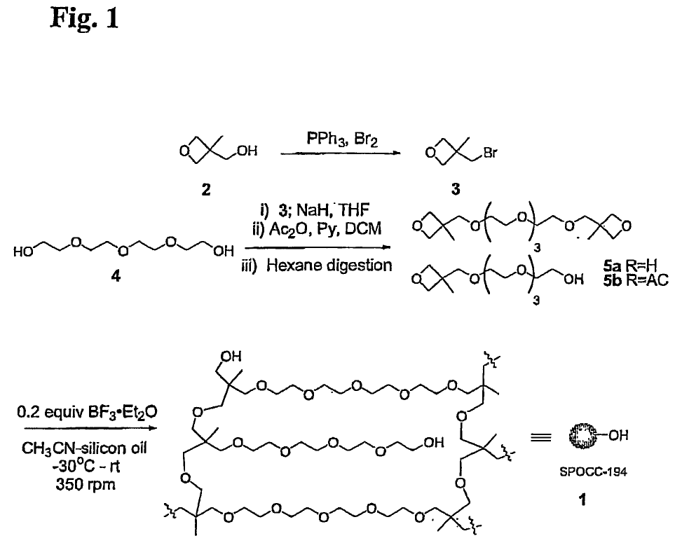

Compounds indicated by numbers herein are illustrated in FIGS. 1, 5, 6, and 7.

General Remarks:

All solvents were purchased from Labscan Ltd. (Dublin, Ireland) and stored over 3Å molecular sieves. Unless mentioned otherwise, bromine, boron-trifluoroetherate, lithium bromide, 3methyl-3-oxetane methanol (oxetane alcohol), triphenyl phosphine, sodium hydride, silicon oil and other chemicals were purchase from Sigma-Aldrich or Fluka Chemicals Inc. Photolabile linker was prepared according to literature procedures²². Aminomethylated polysytrene (AMPS) resin (1.44 mmol/g, 75-150 μm), protected N^{α}-Fmoc amino acids, TBTU and Dhbt-OH were obtained from NovaBiochem (Switzerland). PEGA₁₉₀₀ resin (acryloylated bis(2-aminopropyl)poly(ethylene glycol)/acrylamide copolymer, 0.2 mmol/g. 300-500 μm) was obtained from Polymer Laboratories (Amherst, Mass.). TentaGel S NH² resin (0.2 mmol, 90 μm) was obtained from Rapp-polymere (Tübingen, Germany). SPOCC1500 (0.4 mmol/g, 250 μm) was prepared in-house as previously described¹⁸. Solid-phase peptide chemistry and solid-phase organic chemistry were performed in flat-bottom luer syringes fitted with sintered Teflon filters (50 μm pore size). All reactions involving air sensitive components were carried out under argon or nitrogen atmosphere. Resin hydroxyl group loading was ascertained, after esterification of a weighed resin sample with 0.25 M 9-fluorenylmethyl chloroformate (−20 equiv.) in 1:2 pyridine:DCM for 24 h, by treatment with 20% piperidine in DMF for 2 h and subsequent measurement of the concentration of dibenzofulvene piperidine adduct on observation of the UV band at 290 nm and comparisons with a standard curve created with quantified samples.

Water was deionized with a Milli-Q water purification system (Millipore-Waters). Argon, helium, and nitrogen gas were of ultrapure grade. ¹H NMR (250 MHz) and ¹³C NMR (62.9 MHz) spectra were recorded on a Bruker DRX 250 MHz, and chemical shifts are reported in parts per million (ppm) downfield from internal (CH₃)₄Si. High-resolution magic-angle spinning-NMR experiments were performed on a Bruker DRX600 MHz spectrometer equipped with a 4 mm ¹H—¹³C dual HR-MAS probe-head (when spinning at 4000-10000 Hz). Resin samples were typically examined swelled in CDCl₃- IR spectra were measured on resin using a Perkin-Elmer Paragon 1000 FT-IR spectrometer. Resins samples for FT-IR analysis were swollen in a minimal amount of DCM, and then gently pressed between two NaCl plates.

Reversed phase high-performance liquid chromatography (RP-HPLC.) was performed on a Waters 110 solvent delivery system equipped with a Schimadzu UV absorbance or a Waters M-991 photodiode array detector and chromatograms were recorded on a PC computer using the TurboChrom Navigator 4.1 program (Perkin Elmer). RP-HPLC was performed on a Zorbax C₁₈ (5 μm, 0.46 cm×25 cm) column. Chromatographic separations were achieved using linear gradients of buffer B in A (A=0.1% aqueous TFA; B=90% CH₃CN, 10% H₂O, 0.09% TFA) over 40 min at a flow rate of 1 mL/min.

Electrospray mass spectra were acquired on a Hewlett-Packard HP1100-MSD mass spectrometer equipped with an atmospheric pressure ionization source. Samples were dissolved in 50% aqueous acetonitrile (3 μL) and injected Into a moving solvent (100 μL/min; 50:50 0.3% acetic acid in water/0.03% acetic acid in acetonitrile) that flowed directly to the ionization source via a fused silica capillary interface (50 μm i.d. ×25 cm length). Sample droplets were ionized at a positive potential of 5 kV and entered the analyzer via an interface plate through an orifice (100-120 μm diameter) using a capillary potential of 90 V. Full scan mass spectra were acquired over the mass range of 150-1000 Da with a scan step-size of 0.1 Da Molecular masses were derived from the observed m/z values using the HP LC/MSD Chem-station Rev A.06.03 software packages (HP, USA).

MALDI-TOF spectra were acquired on a Bruker Reflex III MALDI-TOF mass spectrometer. Beads were irradiated on stainless steel targets with an UV lamp for 30 min. The analyte was extracted on the target from the beads using 0.5 mm³ of 70% acetonitrile and then dried at room temperature. The α-cyano4-hydroxycinnamic acid matrix (CHC, 10 mg in 1 cm³ of 70% acetonitrile) was added and the sample was dried at 40° C. Spectra were obtained (1-100 pulses) using the lowest power required for facilitating desorption and ionization. Ions were accelerated toward the discrete dynode multiplier detector with an acceleration voltage of 20 kV.

Preparation of SPOCC₁₉₄ Resin.

(3-Methyl-3-(bromomethyl)oxetane (Oxetane Bromide, 2). This was prepared in one step from 3(hydroxymethyl)-3-methyloxetane (1) using bromine and triphenylphsophine in DCM, and purified by vacuum distillation (55° C. at 17 mbar) in 35% yield according to the previously reported procedures¹⁷. ¹H NMR (250 MHz, CDCl₃) δ 4.45 (q, J=5.95 Hz, 4H), 3.65 (s, 2H), 1.44 (s, 3H).

Bis[(3-methyloxetan-3-yl)methyl]tetraethylene glycol (5). Tetraethylene glycol (3, TEG, 5.0 g, 25.7 mmol) was dried by azeotropic removal of water on concentration from 50 mL volumes of acetonitrile and toluene by evaporation on a rotary evaporator, and then stored for 3 d in vacuo over fresh P₂O₅. The colourless oil was diluted with 20 mL of anhydrous 1:1 DMF:THF, treated slowly with NaH (103 mmol, 400 mol %, a 60% suspension in mineral oil that was removed by washing with dry hexane), stirred vigorously at 37° C. for 3 h under nitrogen, treated over 3 min with oxetane bromide 2 (400 mol %, 103 mmol) and stirred at 37° C. overnight. After cooling to ambient temperature, the reaction mixture was treated carefully with 3 mL of water, stirred for 15 min, and concentrated in vacuo. The residue was digested into 50 mL of DCM, stirred, filtered and concentrated in vacuo. The oil was diluted with DCM (200 mL) and washed with 5% citric acid and brine (2×50 mL). The aqueous phases were back extracted with DCM (4×50 mL). The combined organic phases was dried with Na₂SO₄ and concentrated to an oil, that was digested with hexane (8×100 mL). The collected hexane digestions were concentrated in vacuo to furnish 7-3 g (78%) of a pale yellow oil: ¹H NMR (250 MHz, CDCl₃) δ 4.50 (d, J=5.65 Hz, 4H), 4.33 (d, J=5.65 Hz, 4H), 3.64 (br m, 16H), 3.53 (br d, 4H), 1.30 (t, J=2.51 Hz, 6H); ¹³C NMR, δ80.05, 76.52, 70.93, 70.65, 70.61, 70.48, 39.87, 21.30.

Acetylabon of Oxetanylated Tetraethylene Glycol (5).

A solution of bis[(3-methyloxetan-3-yl)methyl]tetraethylene glycol in 40 mL of 1:1 DCM;pyridine was treated with acetic anhydnrde (5 mL), stirred overnight at room temperature and evaporated in vacuo to give the acetate. The degree of acetylation was quantified by comparing the integrations of the acetyl methyl singlet (2.06 ppm) and the oxetane methylene doublets (4.33 and 4.50 ppm) in the ¹H NMR spectrum. On measurement of the acetate constituent, the yield of oxetarne incorporation was inferred to be in the range of 75-80%.

Suspension Polymerization.

A solution of acetylated macromonomer 5 (1 g, 2.76 mmol) in dry acetonitrile (1 mL) was cooled to −42° C., treated with BF₃.Et₂O (97 μL, 0.773 mmol, 0.2 equiv), and then quickly added dropwise to a silicon oil bath (75 mL) at room temperature stirred at 450 rpm. Emulsification was allowed to occur and polymerization continued with stirring at room temperature for 20 h. The slurry of SPOCC₁₉₄ beads were filtered onto a sintered glass filter and washed with 50 mL volumes of each of the following solutions: DCM, MeOH, 1:1 MeOH:DMF, DMF, THF, MeCN and MeOH. Unreacted oxetane groups were ring-opened on heating the beads in 4M HCl at reflux for 3 h. Acetate groups were cleaved on stirring the beads with 4M NaOH at room temperature for 18 h. Oxetane ring-opening and acetate hydrolysis were monitored by observing the disappearance of resonances at 4.3-5 and 2.1 ppm respectively in the ¹H MAS-NMR spectrum of the resin Beads were sieved between 106-212 μm to provide 0.76 g (76 %) of SPOCC₁₉₄ resin as uniformly shaped and sized beads. This procedure was scaled up for the preparation of 5 g batches of SPOCC₁₉₄.

Swelling Measurements.

Dry resin beads (1 g: SPOCC₁₉₄, AMPS, PEGA₁₉₀₀ and SPOCC₁₅₀₀) were place in a graduated flat-bottom luer syringe fitted with a sintered Teflon filter (50 μm pore size) and swollen in the appropriate solvent for 30 min. The solvated resin bed was then squeezed with a flat plunger with an approximately 50 psi downforce to exclude excess solvent volume. The force was released and the swollen volume was measured. This procedure and measurement was performed in triplicate for each resin sample (typically with ±0.1-0.2 mL reproducibility) and the values were averaged¹⁹.

Peptide Synthesis.

Syntheses were performed on SPOCC₁₉₄ derivatised with 4-{4-[1-(9H-fluoren-9-ylmethoxycarbonylamino)-ethyl]-2-methoxy-5-nitro-phenoxy}-butyric acid (PLL, photolabile linker, 5 equiv)²², using 1-(mesitylene-2-sulfonyl)-3-nitro-1H-1,2,4-triazole (MSNT, 5equiv) and N-methylimidazole (NMl, 3.75 equiv)²⁶. Peptide syrithesis with N^{α}-Fmoc pentafluorophenyl (Pfp)/3,4-dihydro-3-hydroxy4-oxo-1,2,3-benzotriazine (Dhbt-OH) active ester coupling chemistry was performed as previously described²⁷. The N^{α}-Fmoc-Gly-Ser(OH)-Leu-Ala-Phe peptide was then assembled using the following conditions. The N^{α}-Fmoc groups were removed with 50% piperidine in DMF (2×20 min). The resin was then washed thoroughly with DMF (10×5 mL/g resin) and subsequently treated with a 0.4 M solution of Fmoc-amino acid Pfp ester (300 mol %) and Dhbt-OH (100 mol %), in DMF for 4 h. Serine was introduced without side-chain protection as the preformed Pfp ester, N^{α}-Fmoc-Ser(OH)-OPfp. Coupling efficiencies were determined by the ninhydrin test²⁸), and if necessary, re-coupling was performed until no N^{α}-amino groups were present.

Solid-Phase Glycosylation.

The SPOCC₁₉₄-bound pentapeptide 6, N^{α}-Fmoc-Gly-Ser(OH)-Leu-Ala-Phe, was synthesized as described above. Following the last coupling reaction, the resin was thoroughly washed with DMF, THF, and DCM (8×5 mL/g resin), dried in vacuo over P₂O₅ overnight and then stored at −20° C. Glyco-sylation was performed in dry DCM under an, argon atmosphere in a syringe-fitted with a teflon filter that allowed the addition of solvents and catalyst under an Inert atmosphere, The pentapeptide-resin 6 (19 mg; 21 μmol) and the 2,3,4,6-tetra-O-acetyl-α-D-glucopyranosyl trichloroacetimidate donor (105 μmol; 5 equiv), were both dried overnight under high vacuum in the reaction vessel. Dry DCM (200 μL) was injected into the syringe to swell the resin. After 30 min, BF₃Et₂O (3.9 μL, 31.5 μmol; 0.3 equiv to 2,3,4,6-etrae-O-acetyl-α-D-glucopyranosyl trichloroacetimidate donor) was injected and the slurry briefly mixed. After 90 min, suction was applied and the resin was washed with DCM (10 volumes). The above procedure was repeated. The Fmoc group was removed with 50% piperidine/DMF (2×15 min) and after washing with DMF (5×5 mL/g resin) and DCM (7×5 mL/g resin), the glyco-peptide was cleaved by irradiation with a UV lamp in 3% AcOH/MeOH for 2 h at room temperature. Glycopeptde 7 was analysed by RP-HPLC (Rₜ28.3 min; Purity estimate 92%). Mass spectral analysis of the major peak showed the following: ESI-MS: 823.3 [Mᵣ+H]+, 845.3+Na; MALDI-TOF: 844.68 (Mᵣ+Na), calcd. for C₃₇H₅₄N₆O₁₅, 822.36 Da (monoisotopic).

General Sulfone Safety-Catch Linker Preparation.

After neutralisation in 30% DI-PEA in DMF, SPOCC₁₉₄ resin (0.1 mmol) was permethanesulfonated using 100 mol % of methanesulfonyl chloride and pyridine (0.5 mL) in dry DCM (1 mL) at room temperature (2×1 h). The resin 8 was washed with DCM (3×15 mL/g) and DMF (3×15 mL/g), then swollen in DMF (1 mL), treated with β-mercaptoethanol (0.5 mmol) and CsCO₃ (0.5 mmol) and left at rt overnight. The resin was washed with 15 mL/g of the following solvents: DMF, H₂O, DMF, THF and DCM. The resin was dried in vacuo to give SPOCC₁₉₄-S—CH₂CH₂—OH resin 9 which was stored at −20° C.

Attachment and Elimination of p-Nitrobenzoic Acid from Safety-Catch Linker.

Resin linker 9 (120 mg, 0.11 mmol) was treated with p-nitrobenzoylchloride (1.0 mmol, recrystallized from dry pet ether, fraction 60-80° C.) and pyridine (1 mL) in DCM (1 mL) at rt for 3 h and then retreated with the same conditions overnight. The resin was washed with 20 mL/g of resin of the following solvents: DCM, THF, DMF, THF, and DCM. The resin was lyophilized overnight: FT-IR v 3054, 2872, 1731, 1531, 1357 cm ¹. The resin was oxidized to the sulfone by treatment with 12 mL/g resin of m-CPBA in DCM (90 mg/mL) at room temperature overnight: FT-IR v 1261.4 cm⁻¹(SO₂). After washing (20 mL/g of resin) with DCM, THF, DMF, THF and DCM, the resin was lyophilized. The resin was swelled in anhydrous DCM (20 mL/g resin), treated with DBU (0.22 mmol, −2 mol %) and left to sit at rt for 30 min. The DCM solution was filtered and concentrated in vacuo to provide p-nitrobenzoic acid as the DBU salt as determined by ¹H NMR analysis to give a total yield of 65% based on the initial loading estimate. ¹H NMR (250 MHz, CD₃Cl ppm) δ 8.14 (4 Hₐᵣ), 3.39, 2.90, 2.02, 1.73. ¹³C δ 170.7, 166.1, 148.6, 145.1, 130.2, 122.9. 54.3, 48.7, 38.7, 32.4, 29.2, 27.1, 24.3, 23.4,19.9.

Friedel-Crafts Acylation on SPOCC194:

Synthesis of 1,4-Dimethyl-1-[4-(4nitro-benzoyl)-benzyl]-piperazin-1-ium, 17. SPOCC₁₉₄-S—CH₂CH₂—OH resin (0.06 mmol) was prepared as described above. The resin was washed with DMF and DCM, and treated twice with 20 equiv of mesyl chloride (1.2 mmol) in pyridine/DCM (1:1) at room temperature for 3 h. Following a DMF wash, the resin was treated with Boc-piperazine (1.2 mmol) in a 10% triethylamine/DMF solution at 45° C. After 6 h, 5 equiv of DBU (0.3 mmol) was added and left overnight. The resin was washed extensively with DMF and MeOH. The linker thioether was oxidised to the sulfoxide by treatment with 30% H₂O₂ and 5% acetic acid²⁹. The piperzaine Boc group was then removed with neat TFA for 10 min. The presence of free secondary amines on the resin was clearly evident by the chloranil test. Alkylation of the piperazine was performed using a 10% solution of benzyl bromide in DMF with 20 equiv of DBU (0.3 mmol) was added and left overnight at 45° C. After washing with DMF, the chloranil test for free secondary amine was negative; FT-IR NO₂ v 1529;1 cm⁻¹. The resin was then treated with methyl iodide (125 μl, 2 mmol) in dimethylacetamide (DMA) at 50° C. for 3 days³⁰. Oxidation to the linker sulfoxide to the sulfone was performed by suspending the resin twice in mCPBA in DCM (15 mg/mL) at room temperature for 2 h: FT-IR SO₂ v 1267.9 cm⁻¹. The resin was washed thoroughly DCM, DMF, MeOH, THF, MeOH, DCM, and dried in vacuo over P₂O₅. For Friedel-Crafts acylation, aluminium trichloride (AlCl₃, 1.5 mmol) and recrystallized p-nitrobenzoyl chloride (0.3 mmol) in anhydrous nitrobenzene was cooled in an acetone dry ice bath for 10 min under argon. The nitrobenzene solution was then added to the resin under argon and left to warm gradually to room temperature over 3 h. The resin was then heated to 30° C. for 5 h and then washed CCl₄, DMF, MeOH, iso-propanol, water, MeOH, DCM and chloroform. The product was cleaved from the resin with 3 equiv DBU in DMF at rt overnight, and extracted from the beads with 50% acetoni-trile/water and (CD₃)₂SO. Overall isolated yield after 11-steps and HPLC purification: 12%. Higher yields were not expected due to difficulties with on-resin piperazinium formation³⁰. ¹H NMR (250 MHz, CD₃CN-CD₃OD-(CD₃)₂SO, ppm) δ 8.43 (d, J=8.48 Hz, 2Har), 8.03 (d, J=8.79 Hz, 1Hₐᵣ), 7.92 (d, J=8.48 Hz, 2Hₐᵣ), 7.80 (d, J=8.79 Hz, 2Hₐᵣ), 4.79 (s, 2H, CH₂), 3:98 (m, 4H CH₂), 3.43-3.48 (m 4H, CH₂), 3.08 (s, 3H, CH₃), 2.55 (s, 3H, CH₃). ¹³C 194.557 (C═O), 153.73(Cₐᵣ), 142.12(Cₐᵣ), 137.73(Cₐᵣ), 133.84(Cₐᵣ), 132.23(Cₐᵣ), 131.15(Cₐᵣ), 130.37(Cₐᵣ), 129.04(Cₐᵣ), 124.03(Cₐᵣ), 66.54 (CH₂), 58.83 (CH₂), 45.11 (CH₂), 48.2 (CH₃), 37.82 (CH₃). ESI-MS Mr 354.4, cafcd. for C₂₀H₂₄N₃O₃, 354.18 (monoisotopic).

### EXAMPLE 2

### Preparation and Properties of SPOCC₁₉₄

The cross-linked tetraethylene glycol (TEG₁₉₄) polymer, SPOCC₁₉₄ (1) was pre-pared by modification of the reported procedure¹⁴ for synthesizing SPOCC resins with longer chain-length PEG-macromonomers (FIG. 1). Instead of using a Boltzman-like distribution of PEG chain-lengths for the preparation of the resin, the present inventors employed TEG (4) because it is a homogenous, commercially available macromonomer.

Chemically modified TEG macromonomers were found to be of well-defined composition, and could be accurately characterized by NMR spectroscopy In order to minimize batch-to-batch variations. In the polymer, oxetane moieties at the termini of TEG chains serves as the cross-linking unit, and also a site for primary hydroxyl functionality. 3-Hydroxymethyl-3methyl-oxetane (2) was obtained from commercial sources and treated with triphenylphosphine and bromine in DCM to provide its corresponding bromide 3 which was purified by vacuum distillation¹⁷ (FIG. 1).

In earlier syntheses of SPOCC resins, the use of toluenesulfonate and methanesulonate oxetane derivatives was examined; however, it was found that the sulfonate leaving groups were less efficient for resin preparation and caused purification difficulties. Alkylation of the macromonomer was performed by deprotonating TEG with sodium hydride in THF, followed by treatment with oxetane bromide (3). Typically, 75% incorporation yields of the oxetane moiety were obtained as a mixture of mono and bis-oxetanylated TEG. The mixture of mono and bis-oxetanylated TEG was then subjected to acetylating conditions with acetic anhydride and pyridine in DCM to cap the remaining hydroxyl groups. After an aqueous work-up, the TEG₁₉₄ oxetane macromonomers were readily purified and decolourized by continuous extraction into hexane (FIG. 1).

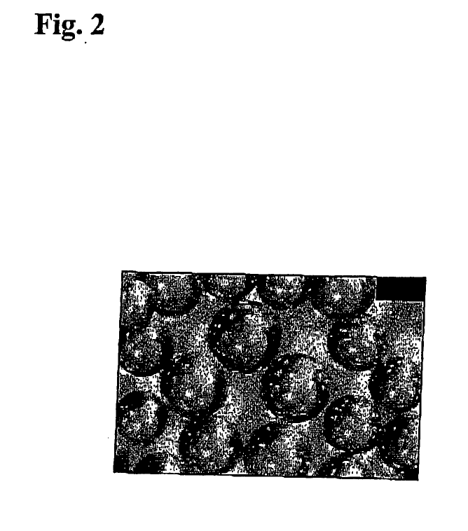

Beaded SPOCC resin Was prepared by BF₃.OEt₂-catalyzed cationic ring-opening suspension polymerization of the pre-cooled TEG-oxetanylated macromonomer in silicon oil at room temperature (FIG. 1). Although the beading of high molecular weight PEG-macromonomers required the use of surfactants for suspension polymerization in silicon oil¹⁸, SPOCC₁₉₄ polymerization proceeded rapidly and gave beaded resin without any additives. After overnight curing, acetate saponification and thorough washing to remove silicon oil, spherical SPOCC₁₉₄ beads were obtained having uniform shape and a white to slightly off-white colour (FIG. 2).

The bead size was controlled by adjustment of the polymerisation-string rate and the size distribution could be further narrowed by a sieving process. In early preparations of SPOCC resins, when sulfonated oxetane moieties were used to prepare macromonomer, resin-trapped impurities such as residual aromatic residues were detected by nano-probe MAS-NMR spectroscopy. These were eliminated from the SPOCC₁₉₄ beads by a combination of improvements in resin synthesis including the employment of 3methyl-3-(4-bromomethyl)oxetane (3) and the use of purified TEG-macromonomer in the beading process. Similarly, these improved procedures have advantageously been adopted for synthesis and beading of high quality SPOCC₁₅₀₀ resin.

The related POEPOP₁₉₄ resin can be readily prepared from the corresponding methyloxirane-TEG macromonomer with comparable benefits (Example 7).

SPOCC₁₉₄ is inert to a range of extreme conditions, including 12N HCl, neat TFA, butyl lithium in THF, sodium in liquid ammonia, as well as heating in thionyl chloride at reflux. The hydroxyl (OH) group loading of SPOCC₁₉₄ was typically determined to be in the range of 0.9-1.2 mmol/g.

SPOCC₁₉₄ is relatively easy to weigh out and transfer. The resin swelled in a range of solvents with a typical volume of about 2-4 mL/g as determined by the syringe method¹⁹ (FIG. 3A).

In water, SPOCC₁₉₄ swelled to a slightly lesser extent than in polar organic solvents. The swelling of SPOCC₁₉₄ in DCM (-4 mL/g) was comparable with aminomethyl polystyrene (AMPS, 6 mL/g), yet considerably lower than SPOCC₁₅₀₀, and PEGA₁₉₀₀ (16 mL/g and 14 mL/g, respectively).

Although swelling values (mL/g) alone are important, the relationship between the resin swelling and loading in terms of mmol per volume (mmol/mL) is significantly more useful for the development and optimization of chemical reaction parameters. Comparing the ratio of loading to swelling volume, SPOCC₁₉₄ exhibited a similar functional group density to AMPS in DCM (˜0.3 mmol/mL), yet possessed an order-of-magnitude more functional groups per resin swelling volume than TentaGel S (0.03 mmol/mL DCM), PEGA₁₉₀₀ (0. 015 mmol/mL DCM) and SPOCC₁₅₀₀ (0.025 mmol/mL DCM).

Assuming that a swollen resin is essential for reactivity of the polymer-supported functional groups, SPOCC₁₉₄ can be readily employed at high reagent concentrations desired for pushing reactions to completion relative to the later three PEG-based resins. In practice the significance is clear if a given solid-phase reaction is to be carried out on these supports at 1 mmol scale with a desired solution-phase reactant (Mol. wt. 250 Da) concentration of 0.5 M. For this reaction on SPOCC₁₅₀₀20 equiv or approximately 5 g of the reactant is required, compared to only 1.75 equiv or about 0.45 g of the same reactant for both AMPS and SPOCC₁₉₄.

### EXAMPLE 3

### Comparison of Reaction Rates on SPOCC₁₉₄, SPOCC₁₅₀₀, TentaGel S and AMPS.

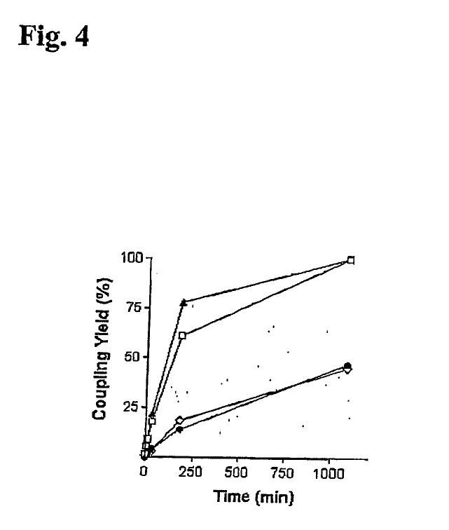

Relative reaction rates on SPOCC₁₉₄, SPOCC₁₅₀₀, TentaGel S and AMPS resins were compared using the model peptide coupling reaction of Boc-Val-OSu with resin-bound Ile-Phe in a minimal amount of DMF to permit salvation (coverage) of the beads. Each resin was treated with 1.5 equivalents of Boc-Val-OSu, and reaction conversion (valine incorporation) ascertained at 1, 5, 10, 30, 180 and 1080 minutes by amino acid analysis of peptide-resin samples (FIG. 4).

In this experiment, the amount of DMF necessary for resin swelling influenced significantly the concentration of the Boc-Val-OSu reactant: SPOCC₁₉₄ (0.39 M), AMPS (0.41 M), SPOCC₁₅₀₀ (0.048 M) and TentaGel S (0.043 M).

The coupling reactions proceeded faster with AMPS and SPOCC₁₉₄, and after 1080 min they were 99.9% and 99.7% complete, respectively. In contrast, the coupling reactions proceeded slower on SPOCC₁₅₀₀ and TentaGel S and were only 45% complete after 1080 min.

The difference in reaction rate and yields are clearly important for scenarios when the availability of a solution-phase reactant is limited or restricted by cost, and generally highlights the usefulness of the resin-bound functional group density term (mmol/mL) for solid-phase synthesis. In practice, this situation is often encountered during the development of effective synthetic procedures in solid-phase organic combinatorial chemistry. On the other hand, when a large excesses and high reactant concentration were employed, for example 50 equiv of Fmoc-Val-O-Pfp at 0.45 M in DMF for 30 min, all of the resins yielded quantitatively the resin-bound tripeptide, Val-Ile-Phe.

### EXAMPLE 4

### MAS-NM1 Properties of SPOCC₁₉₄.

Obtaining NMR spectral data on solid phase bound molecules will lead to broad resonances—due to the heterogeneity of these samples—when using conventional NMR probe technology. High-Resolution Magic Angle Spinning (HR-MAS) NMR spectroscopy provides a more effective means for analyzing resin-supported materials²⁰.

The polymer matrix may influence the quality of HR-MAS NMR spectra of resin-bound compounds. For example, it is known. that resins that provide the greatest mobility of the bound compounds generally produce more narrow ¹H NMR line widths^{6,20d}. Keeping in mind that narrow NMR resonances can only be generated if both the resin-bound compound and the resin itself are well solvated. The quality of HR-MAS NMR spectra measured at different spinning speeds using Fmoc derivatized SPOCC₁₉₄, TentaGel S and AMPS were compared by evaluating the multiplet splitting of the Fmoc aromatic resonances.

The Fmoc aromatic resonances are ideally split into two doublets and two triplets, as is observed in spectra of Tentagel-Fmoc independent of spinning speed (4000-10000 Hz). For the SPOCC₁₉₄ resin these appear as relatively sharp singlets whereas for the PS-DVB-Fmoc these singlets are broader, and overlapped with the aromatic styrene resonances. For the PS-DVB-Fmoc resonances no apparent effect from a change in spinning speed was observed. For the SPOCC₁₉₄ an effect on the peak height is seen between spectra acquired with a spinning rate of 4000 and 6000 Hz, with 6000 Hz giving similar peak height for all four resonances.

The observed increase in peak height with an increase in spinning speed may be attributed to MAS, which is known to reduce dipolar interactions at higher spinning speeds. As expected the data obtained shows the spectra quality to be of the order TentaGel S>SPOCC₁₉₄>PS-DVB. Nevertheless, the quality of the spectra obtained with SPOCC₁₉₄ indicated that in most cases it should be possible to monitor functional group transformations.

### EXAMPLE 5

### Chemistry on SPOCC₁₉₄: Solid-Phase Glycosylation.

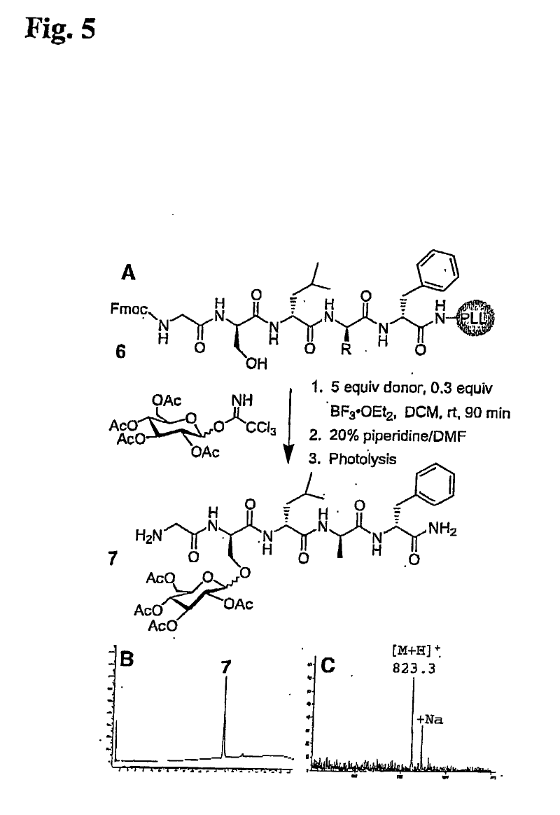

Initially, the utility of SPOCC₁₉₄ was demonstrated by direct solid-phase synthesis of glycopepbtdes which involves the reaction of a peptde hydroxyl group with a highly reactive glycosyl-oxycarbenium ion²¹. Standard Fmoc/OPfp -3,4-dihydro-3-hydroxy-4oxo-1,2,3-benzotriazine (Dhbt-OH) chemistry was used to assemble the N^{α}-Fmoc-protected GS(OH)LAF pentapeptide on SPOCC₁₉₄ derivatized with a photolabile linker (4-{4-[1-(9H-fluoren-9-ylmethoxycarbonylamino)-ethyl]-2-methoxy-5-nitro-phenoxy}butanoic)²². The unprotected serine hydroxyl group was then glycosylated using 2,3,4,6-tetra-O-acetyl-α-D-glucopyranosyl trichloroacetimidate as a donor and BF₃.Et₂O as a Lewis acid catalyst at room temperature for 90 min in anhydrous DCM (FIG. 5A)²¹. Following the glycosylation reaction, the terminal Fmoc group was removed with 50% piperidine in DMF and the glycopeptide was cleaved from the solid-support by UV irradiation. Examination of crude cleavage material by reversed-phase HPLC showed a major product, that was demonstrated to be the expected glucosylated peptide by ES-MS and MALDI-TOF mass spectral analyses (FIG. 5B and 5C).

### EXAMPLE 6

### Friedel-Crafts Acylaton of Resin-Bound Substrates

To further demonstrate the utility of SPOCC₁₉₄ a resin-bound compound was modified by a chemical reaction that would be totally incompatible or impossible on contemporary polystyrene based supports, such as AMPS and TentaGel S. The Friedel-Graft acylation of a resin-bound aromatic substrate using aluminium trichloride was selected because the aromatic nature of AMPS precludes the use of such chemistry for the controlled modification of bound substrate. The reactivity of PS-DVB resin under AlCl₃-catalysed Friedel-Crafts acylations has been previously demonstrated²³, and would thus compete with attempts to selectively modify a resin-bound aromatic substrate.

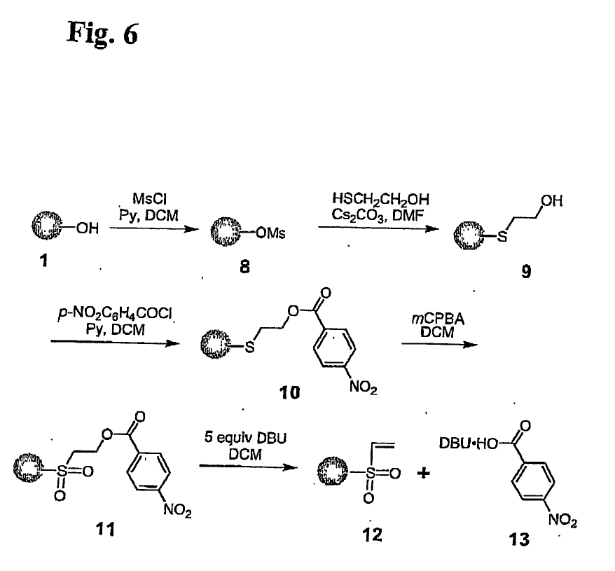

To accomplish this goal, an appropriate non-aromatic linker was required. We attempted initially to adapt the sulfone-based safety-catch β-elimination system for use on SPOCC₁₉₄ resin²⁴. A model system was first examined in which a carboxylic acid served as the leaving group from the safety-catch linker (FIG. 6). The linker was formed on-resin by thiolysis of permethanesuffonated SPOCC₁₉₄ with β-mercaptoethanol in DMF, and subsequently acylated with p-nitrobenzoylchloride in pyridine/DCM to give intermediate ester 10.

Oxidation of the thioether to the sulfone proceeded quickly with excess m-chloroperbenzoic acid in DCM at room temperature. β-Elimination with 1,8-diazabicyclo[5.4.0]undec-7-ene (DBU) then provided the DBU salt of p-nitrobenzoic acid (13) in 65% isolated yield based on the initial loading estimate. Although encouraging and chemically efficient, this ester-linker system was susceptible to significant premature cleavage with nucleophiles and strong acids.

As a result, it was examined if the β-elimination of phenolic ether derivatives from this linker after their acylation under the Friedel-Grafts conditions. Although on-bead FT-IR analysis indicated the formation of a keto moiety after Friedel-Crafts acylation, only trace amounts of the phenolic derivatives could be released from the resin using this strategy. The desired ketone product was, however, detected by ES-MS analysis of the released material.

During the investigation reported herein, Wade and co-workers reported the facile elimination of tertiary amines using a similar sulfone-based safety-catch strategy²⁵, This procedure was thus adapted to the SPOCC₁₉₄ resin in order to investigate the Friedel-Crafts acylation and release of substrate by β-elimination of a tertary amine (FIG. 7). Permethanesulfonated SPOCC₁₉₄ safety-catch linker 14 was displaced with Boc-piperazine in DMF. The thioether was first oxidized to sulfoxide 15 using 30% peroxide. The Boc group was removed from the piperazine moiety with 95% TFA and the secondary amine was alkylated with benzyl bromide.

After sulfoxide oxidation to the sulfone with m-CPBA in DCM, the amines were quaternized with methyl iodide²⁵ to give intermediate 16. The resin was dried and then subjected to Fnedel-Craft acylation conditions with p-nitrobenzoyl chloride in the presence of AlCl₃ in nitrobenzene. After elimination with DBU, the desired Friedel-Crafts product 17 was obtained.

### EXAMPLE 7

### Preparation of POEPOP₁₉₄

(Methyloxirane)-TEG Macromonomer:

Tetratethylene glycol (20 mmol, 3.88 g, TEG, Fluka) was dried by azeotropic evaporation of anhydrous acetonitrile (4×25 mL) at 80° C. and dissolved in anhydrous THF (10 mL) with stirring. Sodium hydride (NaH 60 wt % dispersion in mineral oil, 39.5 mmol, Aldrich) was added in small portions to the TEG solution with stirring. The deprotonation reaction was stirred at room temperature for 22 h. Epichlorohydrin (38 mmol, Fluka) was added dropwise, and the reaction was stirred at 40° C. for 12 h. The solvent was evaporated in vacuo, and the residue was mixed with acetonitrile (50 mL). The precipitated sodium salt was separated by centrifugation at 7000 rpm for 15 min, and the supernatant was decanted and evaporated in vacuo.

Bulk Polymerization:

(Methyloxirane)-TEG macromonomers were heated to 50° C. with stirring and exclusion of moisture. tBuOK (0.1 mmol) was added, and the mixture was stirred until sticky point (approx. 5 min). The temperature was then increased to 110° C. and the polymerization was left for 20 h. The polymer was cooled to room temperature, swollen in toluene (100 mL, 1 h), and cut into pieces before granulation (500 μm) and sieving between 500-212 μm) The collected resin was washed with methanol (3×50 mL), DCM (3×50 mL), water (3×50 mL), methanol (3×50 mL), DMF (3×50 mL), DCM (3×50 mL) and dried under high vacuum. Yield: 3.1 g. Resin loading was determined at 0:9 mmol/g; resin swelling in DCM as determined by the syringe method was estimated at 55-6 mL/g.

### References

1. Hudson, D. J. Combi. Chem., 1999, 1, 333-360.

2. Hudson, D. J. Combi. Chem., 1999, 1403-457.

3. Merrifield, R. S. J. Am. Chem Soc., 1963, 85, 21.49-2154. (a) Dolle R. E., Nelson, K. H. Jr., J. Combi. Chem. 1999, 1, 235-282. (b) R. E. Dolle, J. Combi. Chem., 2000, 2, 383-433.

4. Adams, J. H.; Cook, R. M.; Hudson, D.; Jammalamadaka, V.; Lyttle, M. H.; Songster M. F. J. Org. Chem., 1998, 63, 3706-3716.

5. Grtli, M.; Gotfredsen, C. H.; Rademann, J. Buchardt, J.; Clark, A. J.; Duus, J. .; Meldal; M. J. Combi. Chem., 2000, 2108-119.

7. Olah, G. A in Friedel-Crafts Chemistry, Wiley, N.Y., 1973, p581.

8. Although Friedel-Crafts chemistry has been used to derivatize PS-DVB for the introduction of anchor and linker functionality²³, the modification of resin-bound substrates by Friedel-Craft chemistry had yet to be achieved prior to our study.

9. Rapp, W.; Zhang, L.; Bayer, E. In Solid Phase Synthesis; Epton, R., Ed;. SPCC (U.K.) Ltd.. Birmingham, U.K., 1990, p 205; Meldal, M. Tetrahedron Left., 1992, 33, 3077-3080.

10. Rapp, W. In Combinatorial Peptide and Nonpeptide Libraries: A Handbook; Jung, G., Ed.; John Wiley & Sons, 1998, pp.425464.

11. Renil, M.; Ferreras, M.; Delaisse, J. M.; Foged, N. T.; Meldal, M. J. Pept Sci. 1998, 4, 195-210.

12. Renil, M., Meldal, M. Tetrahedron Lett., 1996, 37, 6185-6188.

13. Buchardt J.; Meldal, M. Tetrahedron Lett., 1998, 39, 8695-8698.

14. Rademann, J.; Grtli, M.; Meldal, M.; Bock, K; J. Amer. Chem. Soc., 1999, 121, 5459-5466.

15. Groth, T., Grtli, M., Lubell. W. D.; Miranda, L. P., Meldal, M., J. Chem. Soc., Perkin Trans. 1, 2000, 4258-4264.

16(a) Smith H. K.; Bradley, M. J. Combi. Chem. 1999, 1, 326-332. (b). St. Hilaire,. P. M., Willert; M.; Juliano M.; Juliano, L.; Meldal, M. J. Combi. Chem. 1999, 1, 509-523. (c) Rossé, G.; Kueng, E.; Page, M.G.P.: Schauer-Vukasinovic, V.; Giller, T.; Lahm, H.-W.; Hunziker, P.; Schlatter D. J. Conbi. Chem. 2000, 2, 461-466.

17. Blaskovich, M. A.; Evindar, G.; Rose, N. G. W.; Wilkinson, S.; Luo, Y.; Lajoie G. A., J. Org. Chem., 1998, 63, 3631-3646.

18. Grtli, M.; Rademan, J.; Groth, T.; Lubell, W. D.; Miranda, L. P.; Meldal, M. J. Comb. Chem., 2001, 3, 28-33.

19. Auzanneau, F.-I.; Meldal, M.; Bock, K. J. Peptide Sci., 1995, 1, 31-44.

20. (a) Keifer, P. A.; Baltusis, L.; Rice, D. M.; Tymiak, A. A.; Shoolery, J. N. J. Magn. Reson. Ser. A, 1996, 119, 65-75; (b) P. A. Keifer, Drug Disc. Today, 2, 468-478 (1997); (c) Lindon, J. C.; Nicholson. J. K. Trends Anal. Chem., 1997, 16, 190-200; (d) Keifer, P. A., J. Org. Chem. 1996, 61, 1558-1559.

21. K. M. Halkes, Gotfredsen, C. H.; Grtli, M.; Miranda, L. P.; Duus, J. ; Meldal, M. Eur. J Chem, 2001, 7, in press.

22. Holmes C. P.; Jones, D. G. J. Org. Chem., 1995, 60, 2318-2319.

23. (a) DeGrado W. F.; Kaiser, E. T. J Org. Chem., 1982, 47, 3258-3261. (b) Wang, S. S. J Org. Chem., 1976, 41, 3258-3261; (c) Mizoguchi, T.; Shigezane, K.; Takamura, N. Chem. Pharm. Bull., 1970, 18, 1465-1474.

24. (a) Kenner, G. W.; McDermott, J. R.; Sheppard, R. C. J. Chem. Soc., Chem. Commun. 1971, 636. (b) Garcia-Echeverria, C. Tetrahedron Lett, 1997, 38, 8933-8934. (c) Katti; S. B.; Misra: P. K.; Haq W.; Mathur, K. B. J. Chem. Soc., Chem. Commun., 1992, 843-844.

25. Wade; W. S.; Yang, F.: Sowin, T. J. J. Comb. Chem., 2000, 2, 266-275.

26. Blankemeyer-Menge, B.; Nimtz, M.; Frank, R. Tetrahedron Lett. 1990. 31, 1701-1704.

27. E. Atherton, L. Cameron, M. Meldal, R. C. Sheppard, J. Chem. Soc., Chem Comm., 1763-1765 (1986))

28. Sarin, V; Kent, S. B. H.; Tam, J. P.: Merrifield, R. B. Anal. Biochem. 1981, 117, 147-157.

29. Ma, S,; Richardson, J. F.; Spatola, A. F.; J. Amer. Chem. Soc., 1991, 113, 8529-8530.

30. (a) Mehta, G.; Sambaiah, T.; Maiya, B. G.; Sirish, M.; Dattagupta, A J. Chem. Soc. Perkin Trans-1;1995, 4; 295-298. (b) Di Tella, S.: Dessaigne, A. M.; Boyer, S.; Maldonado, E.; Ghemri, J. Eur. J. Med. Chem. Chim Ther; 1984,19,131-136. (c) Wang, X W.: Schneider, H-J. J. Chem. Soc. Perkin Trans. 2; 1998, 6, 1323-1328.

1. Polymer matrix comprising a backbone of cross-linked macromonomers, wherein said macromonomers are selected from the group consisting of triethylene glycols, tetraethylene glycols, and pentaethylene glycols, including any combination thereof.

2. Polymer matrix according to claim 1, wherein said macromonomers are selected from the group consisting of triethylene glycols and tetraethylene glycols.

3. Polymer matrix according to any of claims 1 to 2, wherein the matrix does not comprise styrene when the tetraethylene glycol derivative is tetraethylene glycol diacrylate and/or tetraethylene glycol dimethacrylate.

4. Polymer matrix according to any of claims 1 to 3, wherein said matrix is hydrophilic.

5. Polymer matrix according to any of claims 1 to 4, wherein neighbouring macromonomers are linked by quaternary carbon junctions.

6. Polymer matrix according to any of claims 4 to 5, wherein neighbouring macromonomers are linked by primary ether bonds.

7. Polymer matrix according to any of claims 4 to 6, wherein neighbouring macromonomers are linked by quaternary carbon junctions and primary ether bonds.

8. Polymer matrix according to any of claims 4 to 7, wherein at least one end of the matrix terminates in a primary alcohol functionality.

9. Polymer matrix according to claim 4 or 5, wherein the macromonomers are linked by secondary ether bonds.

10. Polymer matrix according to claim 9, wherein at least one end of the matrix terminates in a secondary alcohol functionality.

11. Polymer matrix according to claim 10, wherein at least one first end of the matrix terminates in a primary alcohol functionality and wherein at least one second end of the matrix terminates in a secondary alcohol functionality.

12. Polymer matrix according to claim 1, wherein the matrix is characterised by a ratio R=a/b of essentially 1 (one), wherein a is the number of primary alcohol functionalities and b is the number of secondary alcohol functionalities.

13. Polymer matrix according to any of claims 4 to 8, wherein the matrix is selected from the group consisting of polyoxetane-triethyleneglycol, polyoxetane-tetraethyleneglycol, and polyoxetane-pentaethyleneglycol.

14. Polymer matrix according to any of claims 4 to 8, wherein the matrix comprises the structure 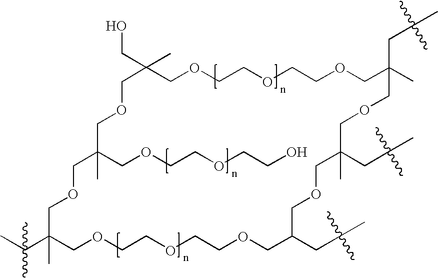
wherein n is 2 and/or 3 and/or 4.

15. Polymer matrix according to claim 14, wherein n is 2.

16. Polymer matrix according to claim 14, wherein n is 3.

17. Polymer matrix according to claim 14, wherein n is 4.

18. Polymer matrix according to any of claims 9 to 11, wherein the matrix is selected from the group consisting of polyglycerol-triethyleneglycol, polyglycerol-tetraethyleneglycol, and polyglycerol-pentaethyleneglycol.

19. Polymer matrix according to any of claims 9 to 11, wherein the matrix comprises the structure 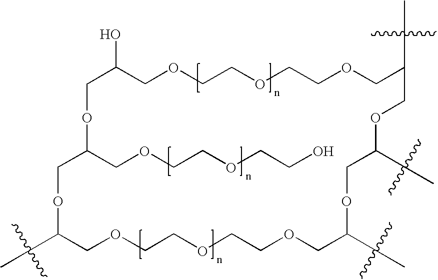
wherein n is 2 and/or 3 and/or 4.

20. Polymer matrix according to claim 19, wherein n is 2.

21. Polymer matrix according to claim 1 9, wherein n is 3.

22. Polymer matrix according to claim 19, wherein n is 4.

23. Polymer matrix according to any of claims 1 to 4, wherein the matrix is selected from the group consisting of poly(acryl)amide-triethyleneglycol, poly(acryl) amide-tetraethyleneglycol, and poly(acryl)amide-pentaethyleneglycol.

24. Polymer matrix according to any of claims 1 to 4, wherein the matrix comprises the structure

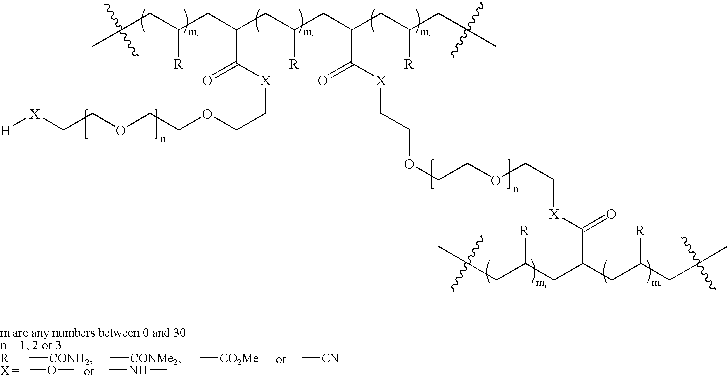

25. Polymer matrix according to claim 24, wherein n is 1.

26. Polymer matrix according to claim 24, wherein n is 2.

27. Polymer matrix according to claim 24, wherein n is 3.

28. Polymer matrix according to claim 24 to 27, wherein R is —CONH₂.

29. Polymer matrix according to claim 24 to 27, wherein R is —CONMe₂.

30. Polymer matrix according to claim 24 to 27, wherein R is —CO₂Me,

31. Polymer matrix according to claim 24 to 27, wherein R is —CN.

32. Polymer matrix according to claim 24 to 31, wherein X is —O—.

33. Polymer matrix according to claim 24 to 31, wherein X is —NH—.

34. Polymer matrix according to claim 26, wherein R is —CONH₂, and wherein X is —O— or —NH—.

35. Polymer matrix according to claim 34, wherein X is —O—.

36. Polymer matrix according to any of claims 1 to 35, wherein the hydroxyl group loading capacity is in the range of from 0.2 mmol/gram to preferably less than 2.0 mmol/gram.

37. Polymer matrix according to any of claims 1 to 35, wherein the hydroxyl group loading capacity is In the range of from 0.4 mmol/gram to preferably less than 1.8 mmol/gram.

38. Polymer matrix according to any of claims 1 to 35, wherein the hydroxyl group loading capacity is in the range of from 0.6 mmol/gram to preferably less than 1.6 mmol/gram.

39. Polymer matrix according to any of claims 1 to 35, wherein the hydroxyl group loading capacity is in the range of from 0.8 mmol/gram to preferably less than 1.4 mmol/gram.

40. Polymer matrix according to any of claims 1 to 35, wherein the hydroxyl group loading capacity is In the range of from 0.9 mmol/gram to preferably less than 1.2 mmol/gram.

41. Polymer matrix according to any of claims 1 to 35, wherein the swelling volume of the matrix in an aqueous liquid, including water, is from 1 ml/gram to preferably less than 5 ml/gram.

42. Polymer matrix according to any of claims 1 to 35, wherein the ratio between i) matrix loading capacity, and ii) swelling volume of the matrix in an aqueous liquid, including water, is in the range of from 0.1 mmol/ml to preferably less than 1.8 mmol/ml.

43. Polymer matrix according to claim 42, wherein said ratio is in the range of from 0.1 mmol/ml to preferably less than 1.5 mmol/ml.

44. Polymer matrix according to claim 42, wherein said ratio is in the range of from 0.1 mmol/ml to preferably less than 1.2 mmol/ml.

45. Polymer matrix according to claim 42, wherein said ratio is in the range of from 0.1 mmol/ml to preferably less than 1.0 mmol/ml.

46. Polymer matrix according to claim 42, wherein said ratio is in the range of from 0.1 mmol/ml to preferably less than 0.75 mmol/ml.

47. Polymer matrix according to claim 42, wherein said ratio is in the range of from 0.1 mmol/ml to preferably less than 0.5 mmol/ml.

48. Polymer matrix according to claim 42, wherein said ratio is in the range of from 0.1 mmol/ml to preferably less than 0.3 mmol/ml.

49. Polymer matrix according to claim 42, wherein said ratio Is in the range of from 0.3 mmol/ml to preferably less than 1.5 mmol/ml.

50. Polymer matrix according to claim 42, wherein said ratio is in the range of from 0.5 mmol/ml to preferably less than 1.5 mmol/ml.

51. Polymer matrix according to claim 42, wherein said ratio is in the range of from 0.75 mmol/ml to preferably less than 1.5 mmol/ml.

52. Polymer matrix according to claim 42, wherein said ratio is in the range of from 1.0 mmol/ml to preferably less than 1.5 mmol/ml.

53. Polymer matrix according to any of claims 1 to 35, wherein essentially all of said macromonomers are identical.

54. Polymer matrix according to claim 53, wherein said macromonomers are triethylene glycol.

55. Polymer matrix according to claim 53, wherein said macromonomers are tetraethylene glycol.

56. Polymer matrix. according to claim 53, wherein said macromonomers are pentaethylene glycol.

57. Polymer matrix according to any of claims 4 to 35, wherein said polymer matrix comprises a mixture of macromonomers selected from triethylene glycol and tetraethylene glycol.

58. Polymer matrix according to any of claims 4 to 35, wherein said polymer matrix comprises a mixture of macromonomers selected from triethylene glycol and pentaethylene glycol.

59. Polymer matrix according to any of claims 4 to 35, wherein said polymer matrix comprises a mixture of macromonomers selected from tetraethylene, glycol and pentaethylene glycol.

60. Polymer matrix according to any of claims 4 to 35, wherein said polymer matrix comprises a mixture of macromonomers selected from triethylene glycol; tetraethylene glycol and pentaethylene glycol.

61. Polymer matrix according to any of claims 53 to 60, wherein said macromonomer or group thereof constitute at least 60% (w/w) of the weight of the polymer matrix.

62. Polymer matrix according to any of claims 53 to 60, wherein said macromonomer or group thereof constitute at least 65% (w/w) of the weight of the polymer matrix.

63. Polymer matrix according to any of claims 53 to 60, wherein said macromonomer or group thereof constitute at least 70% (w/w) of the weight of the polymer matrix.

64. Polymer matrix according to any of claims 53 to 60, wherein said macromonomer or group thereof constitute at least 75% (w/w) of the weight of the polymer matrix.

65. Polymer matrix according to any of claims 53 to 60, wherein said macromonomers constitute at least 80% (w/w) of the weight of the polymer matrix.

66. Polymer matrix according to any of claims 53 to 60, wherein said macromonomers constitute at least 90% (w/w) of the weight of the polymer matrix.

67. Polymer matrix according to any of claims 1 to 35, wherein said macromonomers are not linked by amide bonds.

68. Polymer matrix according to any of claims 1 to 35, wherein said polymer matrix does not comprise a polystyrene comprising portion.

69. Polymer matrix acceding to any of the previous claims, wherein said matrix has a spherical form.

70. A beaded, cross-linked polymer comprising a matrix according to any of claims 1 to 69 having a diameter In the range of from 0.1 μm to preferably less than 5000 μm.

71. The beaded, cross-linked polymer matrix according to claim 70, formed by polymerisation of droplets in silicon oil.

72. The beaded, cross-linked polymer matrix according to claim 70, formed by bulk polymerisation.

73. The beaded, cross-linked polymer matrix according to claim 70, formed by reverse suspension polymerisation.

74. The beaded, cross-linked polymer matrix according to claim 70, formed by spray polymerisation.

75. Use of the polymer matrix according to any of claims 1 to 69, or the beaded, cross-linked polymer according to any of claims 70 to 74, for a support for the synthesis of an organic molecule.

76. Use. of the polymer matrix according to any of claims 1 to 69, or the beaded, cross-linked polymer according to any of claims 70 to 74, for solid phase enzyme reactions.

77. Use of the polymer matrix according to any of claims 1 to 69, or the beaded, cross-linked polymer according to any of claims 70 to 74, for a support for the synthesis of a peptide, a protein, a DNA, and a RNA.

78. Use of the polymer matrix according to any of claims 1 to 69, or the beaded, a cross-linked polymer according to any of claims 70 to 74, for protein immobilisation or affinity purification.

79. Use of the polymer matrix according to any of claims 1 to 69, or the beaded, cross-linked polymer according to. any of claims 70 to 74, for a support for combinatorial chemistry.

80. Use of a macromonomer selected from the group consisting of triethylene glycol, tetraethylene glycol, and pentaethylene glycol, including any combination thereof, in the preparation of a beaded, cross-linked polymer matrix according to any of claims 70 to 74.

81. Composition comprising a plurality of beaded, cross-linked polymers according to any of claims 10 to 74.

82. Composition according to claim 81, wherein the average diameter in the range of from 0.1 μm to preferably less than 5000 μm.

83. Functional surface comprising a polymer matrix according to any of claims 1 to 69, and attached thereto at least one functional moiety.

84. The functional surface according to claim 83, wherein said surface is solid.

85. The functional surface according to claim 83, wherein said surface further comprises a linker residue.

86. Method for preparing a functional surface according to any of claims 83 to 85, said method comprising the steps of
i) cross-linking a plurality of macromonomers selected from the group consisting of triethylene glycol, tetraethylene glycol, and pentaethylene glycol, including any combination thereof, and
ii) contacting said functional surface comprising said cross-linked polymer with at least one functional moiety.

87. Method for targeting a functional moiety attached to a functional surface, said method comprising the steps of
i) providing a functional surface according to any of claims 83 to 85, and
ii) targeting said functional moiety with at least one targeting species having an affinity for said functional moiety.

88. Method for identifying and/or purifying a targeting species having an affinity for a functional moiety, said method comprising the steps of
i) providing a functional surface according to any of claims 83 to 85, and
ii) targeting said functional moiety with at least one targeting species having an affinity for said functional moiety,
iii) identifying and/or purifying the at least one targeting species having an affinity for said functional moiety.

89. Targeting species identified by the method of claim 88.

90. A method for therapy of a human or animal body, said method comprising the step of administering to said human or animal body a targeting species according to claim 89 in a pharmaceutical effective amount.
